(19) United States
(12) Patent Application Publication
(10) Pub. No.: US 2026/0061320 A1
(43) Pub. Date: Mar. 5, 2026

(54) Game Level Verification Methods and Systems

(71) Applicant: Tencent Technology (Shenzhen) Company Limited, Shenzhen (CN)

(72) Inventors: Ziyi Wang, Shenzhen (CN); Boyi Liu, Shenzhen (CN); Chenghao Ye, Shenzhen (CN); Qingbo Yu, Shenzhen (CN)

(21) Appl. No.: 19/324,702

(22) Filed: Sep. 10, 2025

Related U.S. Application Data
(63) Continuation of application No. PCT/CN2024/144245, filed on Dec. 31, 2024.

(30) Foreign Application Priority Data
Jan. 19, 2024 (CN) 202410081101X

(51) Int. Cl. A63F 13/60; A63F 13/56

(52) U.S. Cl. CPC A63F 13/60; A63F 13/56

(57) ABSTRACT

Game level verification methods and systems are described herein. A game level verification technique may include displaying a game level screen, the game level screen including a virtual environment corresponding to a pre-created game level; receiving a verification operation triggered for the game level, the verification operation being configured for triggering an artificial intelligence (AI) model to verify game content of the game level; and displaying error reporting prompt information of the game level in response to the verification operation, the error reporting prompt information being configured for prompting existence of an error location point in the game level, and the error location point being a location point corresponding to game content that the AI model fails to pass in the virtual environment. Thus, the appropriateness of the game level can be verified using an AI model, without needing a player to perform a demo of the game level, improving verification efficiency.

### CROSS-REFERENCE TO RELATED APPLICATIONS

This application is a Continuation of PCT Application No. PCT/CN2024/144245, filed Dec. 31, 2024, and further claims priority to Chinese Patent Application No. 202410081101X, filed on Jan. 19, 2024, each entitled “GAME LEVEL VERIFICATION METHOD AND APPARATUS, DEVICE, MEDIUM, AND PROGRAM PRODUCT”, and each of which is incorporated herein by reference in its entirety.

### FIELD

This application relates to the field of game technologies, and in particular, to a game testing technology.

### BACKGROUND

User generated content (UGC) is a type of gameplay that allows a player to create a game element. For example, the player can create a role, a prop, a plot, a level, or the like. UGC can improve playability and openness of a game, and also provides wide creation space for a game developer. In UGC, the player can build a game level, and then may perform a demo on the game level to verify appropriateness of the game level.

In the related art, a demo button is displayed in a user interface. After completing building the game level, the player may click the demo button to perform the demo on the game level, to verify the appropriateness of the game level.

However, this manner requires the player to perform the demo on the game level, making a verification process time-consuming and labor-consuming and verification efficiency low.

### SUMMARY

This application provides a game level verification method and apparatus, a device, a medium, and a program product, so that a game level can be automatically and intelligently verified, and a player does not need to perform a demo for verification, improving verification efficiency. The technical solutions are as follows.

According to an aspect, a game level verification method is provided, and is performed by a computer device. The method includes:

displaying a game level screen, the game level screen including a virtual environment corresponding to a pre-created game level;

receiving a verification operation triggered for the game level, the verification operation being configured for triggering an artificial intelligence (AI) model to verify game content of the game level; and

displaying error reporting prompt information of the game level in response to the verification operation,

the error reporting prompt information being configured for prompting existence of an error location point in the game level, and the error location point being a location point corresponding to game content that the AI model fails to pass in the virtual environment.

According to another aspect, a game level verification apparatus is provided. The apparatus includes:

a display module, configured to display a game level screen, the game level screen including a virtual environment corresponding to a pre-created game level; and

a receiving module, configured to receive a verification operation triggered for the game level, the verification operation being configured for triggering an AI model to verify game content of the game level.

The display module is further configured to display error reporting prompt information of the game level in response to the verification operation, the error reporting prompt information being configured for prompting existence of an error location point in the game level, and the error location point being a location point corresponding to game content that the AI model fails to pass in the virtual environment.

According to another aspect, a computer device is provided. The computer device includes a processor and a memory. The memory has a computer program stored therein. The computer program is loaded and executed by the processor to implement the foregoing game level verification method.

According to another aspect, a computer-readable storage medium is provided. The computer-readable storage medium has a computer program stored therein. The computer program is loaded and executed by a processor to implement the foregoing game level verification method.

According to another aspect, a computer program product is provided. The computer program product includes computer instructions. The computer instructions are stored in a computer-readable storage medium. A processor obtains the computer instructions from the computer-readable storage medium, so that the processor loads and executes the computer instructions to implement the foregoing game level verification method.

The technical solutions provided in aspects as described herein have at least the following beneficial effects.

The computer device displays the game level screen, the game level screen including the virtual environment corresponding to the pre-created game level; receives the verification operation triggered for the game level, the verification operation being configured for triggering the AI model to verify the game content of the game level; and displays the error reporting prompt information of the game level in response to the verification operation, the error reporting prompt information being configured for prompting existence of the error location point in the game level, and the error location point being the location point corresponding to the game content that the AI model fails to pass in the virtual environment. Accordingly, a player can trigger the AI model to verify the game level only by triggering the verification operation, without a need for other complex interaction and for verification by the player. This can greatly improve efficiency and accuracy of verifying the game level, and improves playability of UGC creation gameplay. In addition, because an interaction manner such as the verification operation is quite simple, learning costs of the player can be maximally reduced, and user experience is further improved.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 is a block diagram of a structure of a computer system according to an illustrative aspect as described herein.

FIG. 2 is a schematic diagram of a game level verification method according to the related art.

FIG. 3 is a schematic diagram of a game level verification method according to an illustrative aspect as described herein.

FIG. 4 is a flowchart of a game level verification method according to an illustrative aspect as described herein.

FIG. 5 is a schematic diagram of a game level verification method according to an illustrative aspect as described herein.

FIG. 6 is a schematic diagram of a game level verification method according to an illustrative aspect as described herein.

FIG. 7 is a schematic diagram of a game level verification method according to an illustrative aspect as described herein.

FIG. 8 is a schematic diagram of a game level verification method according to an illustrative aspect as described herein.

FIG. 9 is a flowchart of a game level verification method according to an illustrative aspect as described herein.

FIG. 10 is a schematic diagram of a game level verification method according to an illustrative aspect as described herein.

FIG. 11 is a schematic diagram of a game level verification method according to an illustrative aspect as described herein.

FIG. 12 is a schematic diagram of a game level verification method according to an illustrative aspect as described herein.

FIG. 13 is a schematic diagram of a game level verification method according to an illustrative aspect as described herein.

FIG. 14 is a schematic diagram of a game level verification method according to an illustrative aspect as described herein.

FIG. 15 is a flowchart of a game level verification method according to an illustrative aspect as described herein.

FIG. 16 is a flowchart of a game level verification method according to an illustrative aspect as described herein.

FIG. 17 is a block diagram of a game level verification apparatus according to an illustrative aspect as described herein.

FIG. 18 is a block diagram of a structure of a computer device according to an illustrative aspect as described herein.

### DETAILED DESCRIPTION

To make objectives, technical solutions, and advantages as described herein clearer, the following further describes implementations as described herein in detail with reference to the accompanying drawings.

Illustrative aspects will now be described in detail, examples of which are represented in the accompanying drawings. When the following descriptions involve the accompanying drawings, unless otherwise indicated, the same numerals in different accompanying drawings represent the same or similar elements. Implementations described in the following illustrative aspects do not represent all implementations consistent with this application. Instead, the implementations are merely examples of apparatuses and methods that are described in detail in the appended claims and that are consistent with some aspects as described herein.

Terms used as described herein are for the purpose of describing specific aspects only and are not intended to limit this application. The singular forms of “a/an”, “the”, and “this” used as described herein and the appended claims are intended to include the plural forms as well, unless the context clearly indicates otherwise. The term “and/or” used herein indicates and includes any or all possible combinations of one or more associated listed items.

Although the terms such as first and second may be used as described herein to describe various information, the information is not limited to the terms. These terms are merely used to distinguish between information of the same type. For example, without departing from the scope as described herein, a first parameter may also be referred to as a second parameter, and similarly, the second parameter may also be referred to as the first parameter. Depending on the context, for example, the word “if” used herein may be interpreted as “while”, “when”, or “in response to determining.”

As described herein, before and during collection of relevant data of a user (for example, data related to a virtual object, a pre-created game level, and a trigger operation on a verification button), a prompt interface or a pop-up window may be displayed, or voice prompt information may be outputted. The prompt interface, the pop-up window, or the voice prompt information is configured for prompting the user that the relevant data of the user is currently being collected. In this way, as described herein, only after a confirmation operation of the user on the prompt interface, the pop-up window, or the voice prompt information is obtained, relevant operations of obtaining the relevant data of the user start to be performed. Otherwise (in other words, when a confirmation operation of the user on the prompt interface, the pop-up window, or the voice prompt information is not obtained), relevant operations of obtaining the relevant data of the user are ended, that is, the relevant data of the user is not obtained. In other words, all user data acquired as described herein is acquired with user consent and authorization, and collection, use, and processing of relevant user data need to comply with relevant laws, regulations, and standards of relevant countries and regions.

First, terms involved in the aspects as described herein are briefly described.

Virtual environment: is a virtual environment displayed or provided when a client is run on a terminal. The virtual environment may be a simulated environment of a real world, a semi-simulated and semi-fictional environment, or an entirely fictional environment. The virtual environment may be any one of a two-dimensional virtual environment, a 2.5-dimensional virtual environment, and a three-dimensional virtual environment. In some aspects, the virtual environment is further configured for supporting a virtual battle between at least two virtual objects, and there are virtual resources available to the at least two virtual objects in the virtual environment. In some aspects, the virtual environment includes a lower left corner region and an upper right corner region that are symmetrical, and each of virtual objects belonging to two enemy camps occupies one of the regions.

Virtual object: is a movable object in a virtual environment. The movable object may be at least one of a virtual character, a virtual animal, and a cartoon character. In some aspects, when the virtual environment is a three-dimensional virtual environment, the virtual object may be a three-dimensional virtual model. Each virtual object has its own shape and volume in the three-dimensional virtual environment, and occupies a part of space in the three-dimensional virtual environment. In some aspects, the virtual object is a three-dimensional character built based on a three-dimensional human skeleton technology. The virtual object achieves different external figures by wearing different skins. In some implementations, the virtual object may alternatively be implemented by a 2.5-dimensional or two-dimensional model. This is not limited in the aspects as described herein.

In response to: This expression is configured for representing a condition or status on which one or more to-be-performed operations depend. When the condition or status is satisfied, the one or more to-be-performed operations may be performed immediately or have a set delay. Unless otherwise specified, there is no chronological order between the plurality of to-be-performed operations.

Artificial intelligence (AI): is a theory, a method, a technology, and an application system that use a digital computer or a machine controlled by a digital computer to simulate, extend, and expand human intelligence, perceive an environment, obtain knowledge, and use the knowledge to obtain an optimal result. In other words, artificial intelligence is a comprehensive technology in computer science, and attempts to understand essence of intelligence and produce a new intelligent machine that can react in a manner similar to human intelligence. Artificial intelligence is to research design principles and implementation methods of various intelligent machines, so that the machines have functions of perception, reasoning, and decision-making.

The artificial intelligence technology is a comprehensive discipline, and relates to a wide range of fields including both hardware-level technologies and software-level technologies. Basic artificial intelligence technologies generally include a sensor, a dedicated artificial intelligence chip, cloud computing, distributed storage, a big data processing technology, a pre-trained model technology, an operating/interaction system, electromechanical integration, and the like. The pre-training model is also referred to as a big model or a basic model, and may be widely used in downstream tasks in various major directions of artificial intelligence after fine-tuning. Artificial intelligence software technologies mainly include several major directions such as a computer vision technology, a voice processing technology, a natural language processing technology, and machine learning/deep learning.

User generated content (UGC): is a type of gameplay. A player may perform an operation such as adjusting a terrain, building a virtual building, and creating an obstacle in the UGC, to form a game level. Logic may be further added to the game level, to form a gameplay map.

Parkour gameplay: is a type of gameplay. A player needs to start from a starting point, overcome countless challenges such as various obstacles, traps, and task execution, and finally reach an end point. A player who spends less time is a winner. The parkour gameplay has been widely applied to various types of games such as a party game and a run game. During an actual application, a parkour gameplay map, that is, a parkour level, may be created by using UGC. The following aspects are described mainly by using an example in which the parkour gameplay is used in a game level.

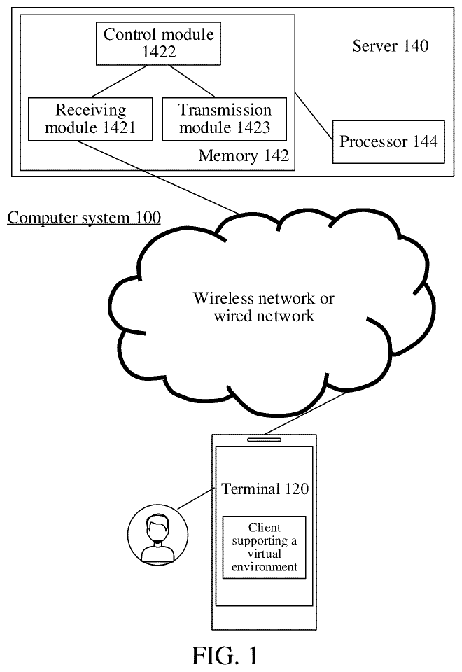

FIG. 1 is a block diagram of a structure of a computer system 100 according to an illustrative aspect as described herein. The computer system 100 may be used as a system architecture for performing a game level verification method in the aspects as described herein. The computer system 100 includes a terminal 120 and a server 140.

A client that provides support for a virtual environment is installed and run on the terminal 120. For example, the client may be any one of a battle royale shooting game, a virtual reality (VR) client, an augmented reality (AR) program, a three-dimensional map program, a virtual reality game, an augmented reality game, a first-person shooting game (FPS), a third-person shooting game (TPS), a multiplayer online battle arena game (MOBA), a simulation game (SLG), a party game, and a run game.

The terminal 120 is a terminal used by a user. The user may control, with the terminal 120, a virtual object located in the virtual environment. This control includes but is not limited to at least one of adjusting a body posture of the virtual object, crawling, walking, running, riding, jumping, driving, picking up, shooting, attacking, throwing, building a virtual building, falling, and performing a task.

In some aspects, the user may further pre-create a game level with the terminal 120 (or another terminal), and after being published, the game level may be provided to another virtual object in a virtual world, for the another virtual object to use. In some aspects, when the user pre-creates the game level with the terminal 120, and triggers a verification operation for the game level, the terminal 120 performs run-through verification on game content of the game level by using an AI model. When there is game content that the AI model fails to pass in the game level, the terminal 120 displays error reporting prompt information of the game level, to prompt existence of an error location point in the game level. In some aspects, the terminal 120 may further optimize game content at the error location point in the game level.

The terminal 120 may communicate with the server 140 over a wireless network or a wired network.

The server 140 may be an independent physical server, a server cluster or distributed system including a plurality of physical servers, or a cloud server providing a basic cloud computing service such as a cloud server providing a cloud computing service, a cloud database, cloud computing, a cloud function, cloud storage, a network service, cloud communication, a middleware service, a domain name service, a security service, a content delivery network (CDN), and a big data and artificial intelligence platform. The server 140 includes at least one of one server, a plurality of servers, a cloud computing platform, and a virtualization center.

For example, the server 140 includes a processor 144 and a memory 142. The memory 142 includes a receiving module 1421, a control module 1422, and a transmission module 1423. The receiving module 1421 is configured to receive a request transmitted by the client, for example, a trigger request for the verification operation. The control module 1422 is configured to control rendering of a virtual environment screen. The transmission module 1423 is configured to transmit a response to the client, for example, transmit the error reporting prompt information to the client. The server 140 is configured to provide a backend service for the client on the terminal 120.

In some aspects, the server 140 is in charge of primary computing works, and the terminal 120 is in charge of secondary computing works. Alternatively, the server 140 is in charge of secondary computing works, and the terminal 120 is in charge of primary computing works. Alternatively, the server 140 and the terminal 120 perform collaborative computing by using a distributed computing architecture.

A form of the client installed on the terminal 120 is not limited in the aspects as described herein, and includes but is not limited to an application (APP), a mini program, and the like installed on the terminal 120, or may be a form of a web page. The terminal 120 may generally be one of a plurality of terminals. In this aspect, only the terminal 120 is used as an example for description. A device type of the terminal 120 includes but is not limited to at least one of a smartphone, a tablet computer, a wearable device, a personal computer (PC), a laptop portable computer, and a desktop computer. The following aspects are described by using an example in which the terminal includes a smartphone.

A person skilled in the art may know that there may be more or fewer terminals 120. For example, there may be only one terminal 120, or there may be a plurality of terminals 120 or more. A quantity and the device type of the terminal 120 are not limited in the aspects as described herein.

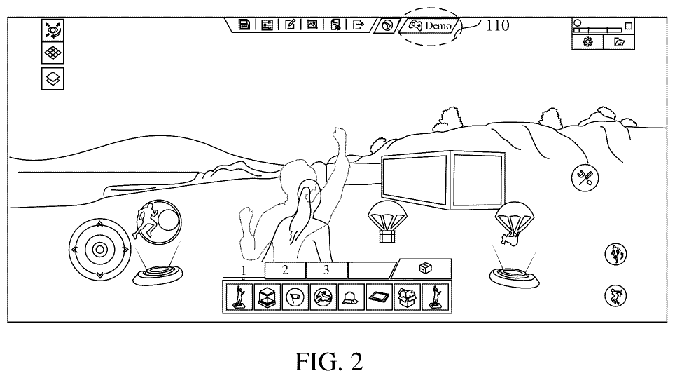

FIG. 2 is a schematic diagram of a game level verification method according to the related art. In the related art, a demo button 110 is displayed in a user interface. After completing building a game level, the player may click the demo button 110 to perform a demo on the game level, to verify appropriateness of the game level. Specifically, the player needs to control a virtual object to perform a run-through demo on each location point on a current route of the game level. When there are a plurality of routes in the game level, the player needs to perform a run-through demo on each route. If it is found during the demo that there is an inappropriate location point on the route, the game level needs to be reset, and after resetting ends, another run-through demo is performed. This process loops until there is no inappropriate location point in the game level. The inappropriate location point is a location point that the virtual object controlled by the player fails to pass in at least one of a walking manner, a jumping manner, a climbing manner, and a falling manner. This manner requires the player to perform the demo on the game level, making a verification process time-consuming and labor-consuming and efficiency low.

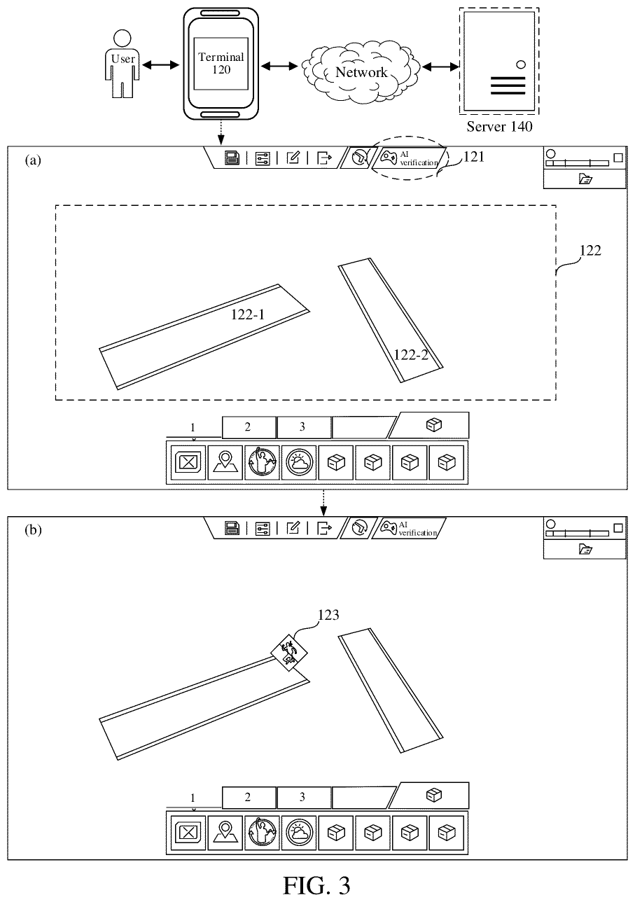

Based on this, FIG. 3 is a schematic diagram of a game level verification method according to an illustrative aspect as described herein. The method is performed by a computer device. The computer device may be the terminal 120 shown in FIG. 1. The terminal 120 has an AI model stored therein. Operations of the game level verification method performed by the terminal 120 are as follows.
1: The terminal 120 displays a game level screen. As shown in (a) in FIG. 3, the game level screen includes a virtual environment corresponding to a pre-created game level 122 and a verification button 121, and the game level 122 includes a road segment 122-1 and a road segment 122-2. The verification button 121 is also referred to as an AI verification button 121, and is configured for triggering the AI model to verify game content of the game level 122. The game content may be set to at least one of the following: A player needs to control a virtual object to reach the road segment 122-2 from the road segment 122-1 in a walking manner (running manner), the player needs to control the virtual object to reach the road segment 122-2 from the road segment 122-1 in a jumping manner, the player needs to control the virtual object to reach the road segment 122-2 from the road segment 122-1 in a climbing manner, or the player needs to control the virtual object to reach the road segment 122-2 from the road segment 122-1 in a falling manner.
2: The terminal 120 receives a trigger operation for the verification button 121, that is, receives a verification operation triggered for the game level 122. The trigger operation is configured for triggering the verification button 121. The trigger operation includes at least one of a click, a double-click, a long-press, a touch, and a slide.
3: The terminal 120 displays error reporting prompt information 123 of the game level in response to the verification operation. The error reporting prompt information 123 is configured for prompting an error location point in the game level 122. The error location point is a location point corresponding to game content that the AI model fails to pass in the virtual environment. As shown in (b) in FIG. 3, the error reporting prompt information 123 is displayed at a location point between the road segment 122-1 and the road segment 122-2 in the game level 122, to prompt that the AI model cannot reach the road segment 122-2 from the road segment 122-1 in the walking manner, to prompt that the AI model cannot reach the road segment 122-2 from the road segment 122-1 in the jumping manner, to prompt that the AI model cannot reach the road segment 122-2 from the road segment 122-1 in the climbing manner, or to prompt that the AI model cannot reach the road segment 122-2 from the road segment 122-1 in the falling manner.

In summary, the game level verification method provided in this aspect as described herein is performed by the computer device. The computer device has the AI model stored therein. The computer device displays the game level screen, the game level screen including the virtual environment corresponding to the pre-created game level; receives the verification operation triggered for the game level, the verification operation being configured for triggering the AI model to verify the game content of the game level; and displays the error reporting prompt information of the game level in response to the verification operation, the error reporting prompt information being configured for prompting existence of the error location point in the game level, and the error location point being the location point corresponding to the game content that the AI model fails to pass in the virtual environment. Accordingly, the player can trigger the AI model to automatically and verify the game level only by triggering the verification operation, without a need for other complex interaction and for verification by the player. This can greatly improve efficiency and accuracy of verifying the game level, and improves playability of UGC creation gameplay.

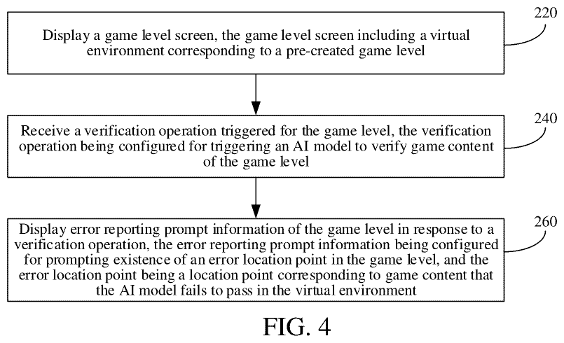

FIG. 4 is a flowchart of a game level verification method according to an illustrative aspect as described herein. An example in which the method is performed by a computer device shown in FIG. 1 is used for description. The computer device may be the terminal 120 shown in FIG. 1. The terminal 120 has an AI model stored therein. The method includes all or a part of operation 220, operation 240, and operation 260.

Operation 220: Display a game level screen, the game level screen including a virtual environment corresponding to a pre-created game level.

The game level screen is a pre-created game level interface displayed by the computer device. The game level screen includes the virtual environment based on which the game level is performed.

In some aspects, the game level screen may be an editing interface of the game level, which is configured for generating the game level after editing. A type of the game level may be at least one of a parkour type, a racing type, and a party type. A type of game content in the game level may include at least one of crossing a gap between two road segments (or turntables, obstacles, or conveyors) in at least one of a walking manner, a jumping manner, a climbing manner, and a falling manner, completing a specified game task, picking up a specified game prop, and making a specified action.

In some aspects, the game level may be pre-created before operation 220. The game level may be pre-created by a player by using the computer device in this aspect. Alternatively, the game level may be pre-created by a player on another computer device, and the another computer device transmits a related data file of the pre-created game level to the computer device in this aspect, so that the game level screen is displayed on the computer device in this aspect.

For example, the computer device has an AI model stored therein. The AI model is configured for verifying the game content of the game level, to determine whether there is game content that the AI model fails to pass in the game level. For example, the game content that the AI model fails to pass may be: The AI model fails to jump across two road segments due to an excessive distance between the two road segments, fails to jump or climb across two road segments (the previous road segment is lower than the subsequent one) due to an excessive height difference between the two road segments, and fails to jump or fall onto the subsequent road segment (lower than the previous adjacent road segment) due to an excessive distance to a landing point on the subsequent road segment.

In some aspects, the game level screen may further include a verification button, and the verification button is a button for triggering the AI model to verify the game content of the game level. In some aspects, the verification button may be in at least one display form of a circle, a square, and a polygon. The verification button may further display a prompt text for prompting a function of the verification button. For example, the verification button is displayed as a square, and displays “AI verification”.

For example, the computer device displays the game level screen, the game level screen includes the pre-created game level and the verification button, and the verification button is configured for triggering the AI model to verify the game content of the game level. The verification button may alternatively be displayed as an AI verification button.

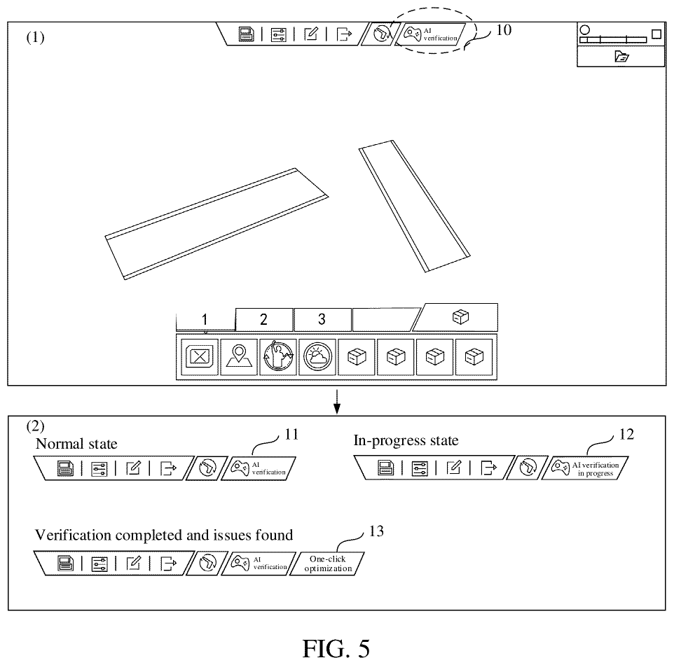

In a possible implementation, FIG. 5 is a schematic diagram of a game level verification method according to an illustrative aspect as described herein. As shown in (1) in FIG. 5, a verification button 10 is displayed at an uppermost location of the game level screen, and the verification button 10 is displayed as “AI verification”. If the player clicks the verification button 10, the computer device verifies the game content of the game level by using the AI model.

Operation 240: Receive a verification operation triggered for the game level, the verification operation being configured for triggering the AI model to verify the game content of the game level.

The player may trigger the verification operation for the game level, to trigger the AI model through the verification operation to verify the game content of the game level. The verification operation may include but is not limited to a trigger operation for the verification button, a preset gesture operation, a voice control operation, and the like.

In a possible implementation, the verification operation may be the trigger operation for the verification button. In some aspects, the trigger operation includes at least one of a click, a double-click, a long-press, a touch, and a slide. For example, the computer device receives the trigger operation for the verification button, to trigger the AI model to verify the game content of the game level.

In some aspects, the verification button includes three display states: a normal state, an in-progress state, and a complete state. The normal state is a display state before triggering of the verification button. The in-progress state is a display state during verification on the game content of the game level by the AI model after triggering of the verification button. The complete state is a display state after completion of verification on the game content of the game level by the AI model. The three states are different in at least one of a display text, a display color, a display icon, a display element, and a display animation.

In a possible implementation, still refer to FIG. 5. As shown in (2) in FIG. 5, the verification button 10 includes three states: a normal state 11, an in-progress state 12, and a complete state 13. The normal state 11 is displayed as “AI verification”. The in-progress state 12 is displayed as “AI verification in progress . . . ”. The complete state 13 is displayed as “AI verification”. In addition, when there is the game content that the AI model fails to complete in the game level, a “One-click optimization” button is displayed on the right of “AI verification”.

The verification operation is configured for triggering the AI model to verify the game content of the game level. Specifically, whether the game content is set appropriately and whether a virtual object fails to normally pass the game content need to be verified. An example in which the game level is a parkour level is used. What needs to be verified includes but is not limited to whether a relevant parameter of an obstacle deployed on a parkour route is appropriate (for example, whether a height and a width of the obstacle are set appropriately, and whether the virtual object fails to pass the obstacle in the jumping manner), whether a relevant parameter between two adjacent road segments on the parkour route is appropriate (for example, whether a distance and a height difference between the two road segments are set appropriately, and whether the virtual object can reach one road segment from the other road segment through walking, jumping, climbing, or falling). The AI model herein is an AI model used for automatically experiencing the game content, and may be specifically parkour game AI.

Operation 260: Display error reporting prompt information of the game level in response to the verification operation, the error reporting prompt information being configured for prompting existence of an error location point in the game level, and the error location point being a location point corresponding to the game content that the AI model fails to pass in the virtual environment.

The error reporting prompt information is information for prompting existence of the game content that the AI model fails to pass in the game level. The error reporting prompt information is configured for prompting existence of the error location point in the game level. The error location point is the location point corresponding to the game content that the AI model fails to pass in the virtual environment, that is, a location of the game content that the AI model fails to pass in a virtual coordinate system corresponding to the virtual environment.

The game content that the AI model fails to pass is game content that the virtual object controlled by the AI model fails to successfully complete. The example in which the game level is the parkour level is still used. The game content that the AI model fails to pass may be specifically a road block in the parkour level, for example, an obstacle that the virtual object controlled by the AI model fails to jump across on the parkour route, or a gap between road segments that the virtual object controlled by the AI model fails to cross on the parkour route through walking, jumping, climbing, or falling. For such game content that the AI model fails to pass, the AI model fails to pass the game content because a parameter for this part of game content is set inappropriately (for example, a parameter for obstacles is set inappropriately, and a parameter for road segments is set inappropriately) when the player creates the game level. Therefore, an error reporting prompt needs to be provided for this part of game content, to prompt the player creating the game level to optimize this part of game content.

More specifically, the game content that the AI model fails to pass is game content whose content parameter does not match a motion parameter of the virtual object controlled by the AI model. To be specific, when the player creates the game level, if a content parameter set for a piece of game content does not match the motion parameter of the virtual object, it is considered that the game content is game content that the AI model fails to pass. That the content parameter of the game content does not match the motion parameter of the virtual object may be understood as that when the AI model controls the virtual object to perform a corresponding motion based on the motion parameter corresponding to the virtual object, the virtual object fails to pass the game content having the content parameter. On the contrary, if the content parameter of the game content matches the motion parameter of the virtual object, when the AI model controls the virtual object to perform a corresponding motion based on the corresponding motion parameter, the virtual object fails to pass the game content having the content parameter. Generally, the motion parameter of the virtual object controlled by the AI model is the same as a motion parameter of a virtual object controlled by an ordinary player.

For example, for the virtual object controlled by the AI model, a corresponding jump height (in a longitudinal direction) and a corresponding jump distance (in a lateral direction) are preset. The jump height and the jump distance are correspondingly equal to a jump height and a jump distance of the virtual object controlled by the ordinary player. When the AI model controls the virtual object to perform a jump operation, the virtual object may reach the preset jump height in the longitudinal direction and reach the preset jump distance in the lateral direction. When the game level includes an obstacle that the virtual object needs to jump across, if a height of the obstacle exceeds the jump height of the virtual object, the virtual object cannot jump across the obstacle, and in this case, the obstacle is game content that the AI model fails to pass; or if a height of the obstacle does not exceed the jump height of the virtual object, the virtual object fails to jump across the obstacle, and in this case, the obstacle is game content that the AI fails to pass. When the game level includes a gap between two road segments that the virtual object needs to jump across, if a width of the gap exceeds the jump distance of the virtual object, the virtual object cannot jump across the gap between the road segments, and in this case, the gap between the two road segments is game content that the AI fails to pass; or if a width of the gap does not exceed the jump distance of the virtual object, the virtual object fails to jump across the gap between the road segments, and in this case, the gap between the two road segments is game content that the AI fails to pass.

In some aspects, the game level includes a plurality of road segments. The game content may be set to at least one of the following: The player needs to reach a road segment 2 from a road segment 1 in the walking manner, the player needs to reach the road segment 2 from the road segment 1 in the jumping manner, the player needs to reach the road segment 2 from the road segment 1 in the climbing manner, or the player needs to reach the road segment 2 from the road segment 1 in the falling manner. The error location point may be a location point between two road segments. The computer device displays the error reporting prompt information at the error location point. The error reporting prompt information may be configured for prompting at least one of the following: prompting that the AI model fails to reach the road segment 2 from the road segment 1 in the walking manner, prompting that the AI model fails to reach the road segment 2 from the road segment 1 in the jumping manner, prompting that the AI model fails to reach the road segment 2 from the road segment 1 in the climbing manner, or prompting that the AI model fails to reach the road segment 2 from the road segment 1 in the falling manner.

For example, the computer device displays the error reporting prompt information of the game level in response to the verification operation. The error reporting prompt information may be represented by at least one of a display element, a display icon, a display text, a display color, and a display animation. The error reporting prompt information is determined by using the AI model, and the error reporting prompt information is displayed on the computer device, so that the game level can be verified without a need for the player to perform a demo.

In summary, the game level verification method provided in this aspect as described herein is performed by the computer device. The computer device has the AI model stored therein. The computer device displays the game level screen, the game level screen including the virtual environment corresponding to the pre-created game level; receives the verification operation triggered for the game level, the verification operation being configured for triggering the AI model to verify the game content of the game level; and displays the error reporting prompt information of the game level in response to the trigger operation, the error reporting prompt information being configured for prompting existence of the error location point in the game level, and the error location point being the location point corresponding to the game content that the AI model fails to pass in the virtual environment. Accordingly, the player can trigger the AI model to verify the game level only by triggering the verification operation, without a need for other complex interaction and for verification by the player. This can greatly improve efficiency and accuracy of verifying the game level, and improves playability of UGC creation gameplay. In addition, because an interaction manner such as the verification operation is quite simple, learning costs of the player can be maximally reduced, and user experience is further improved.

### Display of the Error Reporting Prompt Information

In some aspects, operation 260 is implemented as operation 262 and operation 264.

Operation 262: Display a demo screen in response to the verification operation, the demo screen being a screen for watching a demo of the game content of the game level by the virtual object, and the virtual object being a visual model corresponding to the AI model in the game level.

For example, the computer device has the AI model stored therein. When the AI model verifies the game level, the verification process may also be displayed by the computer device. The AI model may be displayed as the virtual object. The virtual object is the visual model corresponding to the AI model in the game level, and the virtual object is consistent with a virtual object manipulated by another player in a game. The virtual object corresponding to the AI model may also perform at least one of adjusting a body posture, crawling, walking, running, riding, jumping, driving, picking up, shooting, attacking, throwing, building a virtual building, falling, and performing a task.

In some aspects, the computer device displays the demo screen in response to the verification operation. The demo screen is a screen for watching the demo of the game content of the game level by the virtual object from a perspective of a creator of the game level. For example, when the perspective of the creator of the game level is a first-person perspective, the demo screen is a first-person perspective screen. When the perspective of the creator of the game level is a third-person perspective, the demo screen is a third-person perspective screen. In a process in which the AI model verifies the game level, when the perspective of the creator of the game level is switched from the first-person perspective to the third-person perspective, the demo screen is switched from the first-person perspective screen to the third-person perspective screen.

For example, a display form such as a facial form, dressing, a hair style, and skin of the virtual object corresponding to the AI model may be set based on a theme or a type of the game, the game level, and the game content, or may be preset by the creator of the game level. For example, the game level is a party game level of an animal type, and the virtual object corresponding to the AI model may be in a display form of a virtual animal. In this case, the creator of the game level may see a demo screen in which the virtual animal corresponding to the AI model performs a demo on the game level.

In some aspects, the computer device displays the demo screen in response to the verification operation. The demo screen may be displayed in a main interface of the computer device; may be displayed in a small map interface of the computer device, where the small map interface may be located at an upper left corner, an upper right corner, a lower left corner, or a lower right corner of a main interface; or may be displayed on both a main interface and a small map interface of the computer device, where the main interface and the small map interface may correspond to a same perspective or different perspectives of the creator of the game level. This is not limited in this aspect.

In some aspects, the creator of the game level also corresponds to a virtual object. In a process in which the creator watches the virtual object corresponding to the AI model performing the demo on the game content of the game level, the AI model controls the virtual object corresponding to the creator. Although the creator cannot control the virtual object corresponding to the AI model, the creator can still control the virtual object of the creator, for example, move a location of the virtual object or change skin of the virtual object. The creator may further perform an edit operation on the game level. The edit operation is mainly for an appearance of the game level, for example, changing a theme of the game level, modifying a color of a three-dimensional model in the game level, or decorating the game level.

Operation 264: Display the error reporting prompt information on the demo screen.

For example, the computer device displays the error reporting prompt information of the game level on the demo screen.

In some aspects, the demo screen and the error reporting prompt information are synchronously displayed. To be specific, when the AI model performs the demo on the game level, if there is the error location point, the error reporting prompt information is synchronously displayed during a demo process of the game level. In this manner, computing power of the computer device can be reduced. Alternatively, in some other aspects, the demo screen and the error reporting prompt information are asynchronously displayed. To be specific, after the AI model ends the demo on the game level, if there is the error location point, the error reporting prompt information is displayed at a time. In this manner, all error location points can be displayed at a time, improving prompt efficiency of the computer device.

In this aspect, the AI model is displayed as a virtual object on the demo screen, and the creator of the game level can observe the process in which the virtual object performs the demo on the game level. This improves a visualization degree of a verification process performed by the AI model, and helps the creator determine verification progress of the AI model with the demo screen, improving user experience of the creator.

### Display of the Demo Screen

In some aspects, the virtual object is the virtual object corresponding to the AI model, there is at least one virtual object, and the game level includes at least one route. Operation 262 is implemented as operation 262-1.

Operation 262-1: Display, in response to the verification operation, the demo screen in which the at least one virtual object travels along the at least one route.

The game level includes the at least one route, and the AI model needs to perform a demo on each route in the at least one route, to ensure that each route in the at least one route is verified. In this case, the computer device displays, in response to the verification operation, the demo screen in which the at least one virtual object moves along the at least one route. The at least one virtual object is controlled by the AI model. In a movement process, the at least one virtual object may move in at least one of the walking manner, the jumping manner, the climbing manner, and the falling manner, so that the virtual object can not only verify each route but also complete game content on each route.

In some aspects, with reference to a road in a real world, the road includes road segments, and for at least one road from a starting point to an end point, the at least one road may include a common road and forked roads. In a virtual scene, for at least one route, the at least one route includes a plurality of road segments, and the at least one route includes at least one common road segment and at least two forked road segments.

In this aspect, it is set that the at least one virtual object corresponding to the AI model includes a first virtual object and a second virtual object, and the second virtual object is obtained by duplicating the first virtual object. In this case, there is at least one first virtual object on the at least one common road segment, there is at least one second virtual object on each of the at least two forked road segments, and a quantity of the second virtual objects corresponds to a quantity of the at least two forked road segments.

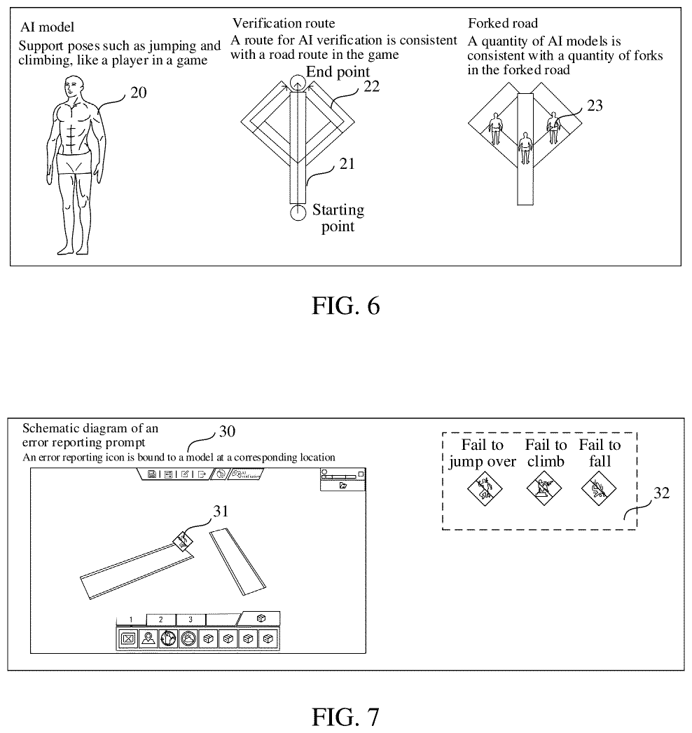

In a possible implementation, FIG. 6 is a schematic diagram of a game level verification method according to an illustrative aspect as described herein. In the game level, the AI model corresponds to a virtual object 20, and a figure of the virtual object 20 is consistent with another virtual object in the game. The game level includes the at least one route from a starting point to an end point, and the at least one route includes one common road segment 21 and three forked road segments 22. In the demo screen, one virtual object 20 is displayed moving on the common road segment 21. When moving to a fork of the three forked road segments 22, the one virtual object 20 is duplicated to obtain three same virtual objects 23, and one virtual object 23 is displayed moving on each of the three forked road segments 22. In addition, when three forked road segments 22 are merged again into one common road segment 24 (not shown), the three same virtual objects 23 are merged again into one virtual object 20, and the one virtual object 20 is displayed moving on the common road segment 24. The virtual object 20 is a first virtual object, and the virtual object 23 is a second virtual object.

In this aspect, the AI model controls the virtual object corresponding to the AI model, and the creator may observe the verification process of the virtual object corresponding to the AI model, so that the visualization degree of the verification process is improved. In addition, when there are forked road segments in the game level, a plurality of virtual objects corresponding to the AI model may be obtained through duplication, and each virtual object may verify one forked road segment. First, this can improve verification efficiency of the game level. Second, this can adaptively adjust a visual display manner based on a road segment, enriching the visual display manner and further improving flexibility of visual display.

### Error Reporting Prompt Manner

The following aspect provides a plurality of error reporting prompt manners. During an actual application, the error reporting prompt information may be displayed in any manner, or a plurality of types of error reporting prompt information may be displayed simultaneously in a plurality of manners. This is not limited in this aspect.

### Error Reporting Prompt Manner 1

In some aspects, the error reporting prompt information includes an error reporting prompt element. Operation 264 is implemented as operation 264-1.

Operation 264-1: Display the error reporting prompt element at the error location point in the demo screen, the error reporting prompt element being configured for prompting that a current location point is the error location point.

The error reporting prompt element is a display element for prompting that the current location point is the error location point.

For example, the computer device displays the error reporting prompt element of the game level at the error location point on the demo screen. The error reporting prompt element is configured for prompting that the current location point is the error location point. To make the error reporting prompt element more conspicuous, a display color of the error reporting prompt element may be red.

In some aspects, the computer device may display different error reporting prompt elements based on different types of the error location point. The type of the error location point includes failing to pass the error location point in at least one of the walking manner, the jumping manner, the climbing manner, or the falling manner.

In this aspect, the error reporting prompt element is displayed at the error location point in the game level, so that the player can precisely prompted that the current location point is the error location point, helping the player to determine the error location point. In addition, because the error reporting prompt element corresponds to the type of the error location point, the error location point and the type corresponding to the error location point can be displayed by using one error reporting prompt element, improving error reporting efficiency and effects.

### Error Reporting Prompt Manner 2

In some aspects, the error reporting prompt information includes an error reporting prompt text. Operation 264 is implemented as operation 264-2.

Operation 264-2: Display the error reporting prompt text in a text display region in the demo screen, the error reporting prompt text being configured for indicating the type of the error reporting location point, and the type including failing to pass the error location point in at least one of the walking manner, the jumping manner, the climbing manner, or the falling manner.

The text display region may be a display region on a right side, a left side, an upper side, or a lower side in the demo screen.

The error reporting prompt text is configured for prompting the type of the error location point. The error reporting prompt text may correspond to the error reporting prompt element. Because the computer device may display different error reporting prompt elements based on different types of the error location point, correspondingly, the computer device may also display different error reporting prompt texts.

For example, the computer device displays, in the text display region in the demo screen, the error reporting prompt text corresponding to the error reporting prompt element of the game level. The error reporting prompt text is configured for indicating the type of the error location point. The type of the error location point includes failing to pass the error location point in at least one of the walking manner, the jumping manner, the climbing manner, or the falling manner.

In this aspect, the error reporting prompt text is displayed in the text display region, so that the player can be precisely prompted that the current location point is the error location point, helping the player to determine the error location point. In addition, the error reporting prompt text can indicate the type of the error location point, which can improve the error reporting efficiency and effects, and further help the player subsequently optimize the error location point manually or by using the AI model.

In a possible implementation, FIG. 7 is a schematic diagram of a game level verification method according to an illustrative aspect as described herein. FIG. 7 includes a display region 30 for error reporting prompt elements and a display region 32 for error reporting prompt texts. An error reporting prompt element 31 is displayed at the error location point in the display region 30. Error reporting prompt texts corresponding to different error reporting prompt elements are displayed in the display region 32. The error reporting prompt text may be at least one of the following: failing to jump across, failing to climb, and failing to fall.

### Display of an Optimization Button

In some aspects, after operation 260, the method further includes operation 280.

Operation 280: Display the optimization button at a location of the error location point, the optimization button being configured for triggering optimization on the game content corresponding to the error location point.

The optimization button is a button for triggering optimization on the game content corresponding to the error location point in the game level. In some aspects, the optimization button may be in at least one display form of a circle, a square, and a polygon. The optimization button may further display a prompt text for prompting a function of the optimization button. For example, the optimization button is displayed as a square, and displays “intelligent optimization” or “on-click optimization”.

For example, the computer device displays the optimization button in a peripheral region of the error location point, for example, at a location whose distance to the error location point is less than a preset distance threshold, the optimization button being configured for triggering the AI model to optimize the game content corresponding to the error location point. The AI model used in the optimization process and the AI model used in the verification process may be a same AI model, or may be different AI models. This is not limited in this aspect. The optimization button may alternatively be displayed as an AI optimization button, an AI intelligent optimization button, and an AI one-click optimization button.

In this aspect, the optimization button is displayed in the peripheral region of the error location point, so that it is convenient for the player to click the optimization button, a visualization degree for optimizing the game content corresponding to the error location point is improved, and subsequent automatic and intelligent optimization on the error location point is facilitated, improving optimization intelligence and optimization efficiency.

The following aspect provides a plurality of optimization button display manners. During an actual application, the optimization button may be displayed in any manner, or a plurality of optimization buttons may be displayed simultaneously in a plurality of manners. This is not limited in this aspect.

### Optimization Button Display Manner 1

In some aspects, operation 280 is implemented as operation 280-1.

Operation 280-1: Display, in response to a location point selection operation triggered based on the error location point, a first optimization button based on a location of a first error location point indicated by the location point selection operation, the location point selection operation being configured for selecting the first error location point from the error location point, the optimization button including the first optimization button, and the first optimization button being configured for triggering optimization on game content corresponding to the first error location point.

The first optimization button is a button for triggering optimization on the game content corresponding to the first error location point. The first error location point is any error location point in a selected region in the game level screen. In some other aspects, when there are a plurality of error location points in the selected region, an error location point closest to the virtual object corresponding to the creator of the game level is determined as the first error location point.

The location point selection operation is configured for selecting the selected region in the game level screen, to select the first error location point from the error location point. In some aspects, the location point selection operation includes at least one of a click, a double-click, a long-press, a touch, and a slide.

For example, the computer device displays, in response to the location point selection operation triggered based on the error location point, the first optimization button in a peripheral region of the first error location point indicated by the location point selection operation, for example, at a location whose distance to the first error location point is less than the preset distance threshold. The location point selection operation is configured for selecting the first error location point from the error location point. The optimization button includes the first optimization button. The first optimization button is configured for triggering optimization on the game content corresponding to the first error location point. In some other aspects, the first optimization button is also referred to as an intelligent optimization button.

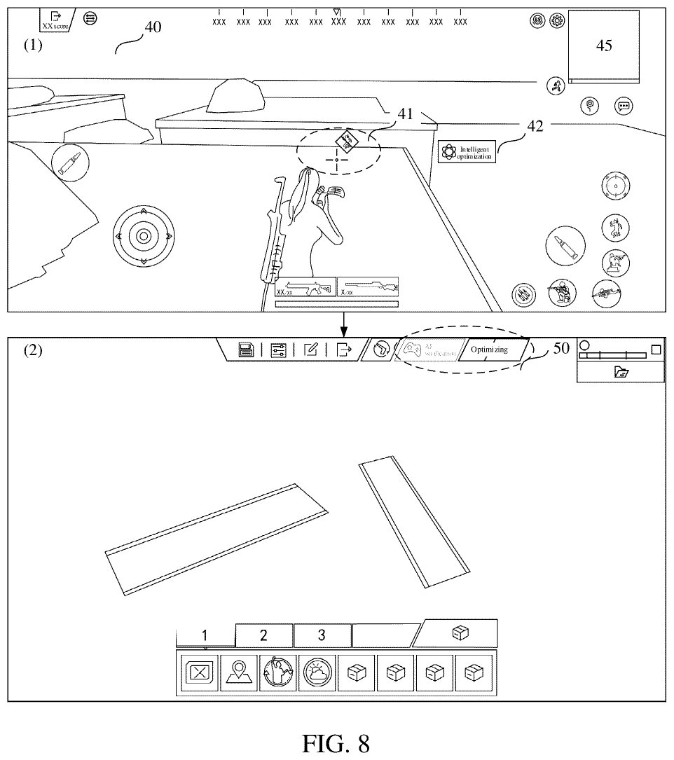

In a possible implementation, FIG. 8 is a schematic diagram of a game level verification method according to an illustrative aspect as described herein. An example in which the optimization button is the first optimization button is used. As shown in (1) in FIG. 8, in the demo screen, the player controls a crosshair to perform the location point selection operation to select an error location point corresponding to an error reporting prompt element 41. In this case, the computer device displays an intelligent optimization button 42 in a peripheral region of the error location point corresponding to the error reporting prompt element 41. After the player triggers the intelligent optimization button 42, the computer device triggers the AI model to optimize game content corresponding to the error location point.

In this aspect, the first optimization button is displayed in a peripheral region of the first error location point indicated by the location point selection operation, so that after the player clicks the first optimization button, the first error location point can be pertinently optimized. This improves optimization pertinence and flexibility, and can improve participation of the player in an optimization process, improving user experience.

### Optimization Button Display Manner 2

In some aspects, operation 280 is implemented as operation 280-2.

Operation 280-2: Display a second optimization button at the location of the error location point, the optimization button including the second optimization button, the second optimization button being configured for optimizing game content corresponding to a second error location point, and the second error location point being all or at least a part of the error location point, or the second error location point being all or at least a part of error location points other than the first error location point.

The second optimization button is a button for triggering optimization on the game content corresponding to the second error location point. The second error location point is all or at least a part of the error location point, or the second error location point is all or at least a part of the error location points other than the first error location point. In other words, operation 280-2 may be performed after operation 280-1, or operation 280-2 may be a parallel operation of operation 280-1, and may be performed in parallel with operation 280-1.

For example, the computer device displays the second optimization button in a peripheral region of the second error location point, for example, at a location whose distance to the second error location point is less than the preset distance threshold. The optimization button includes the second optimization button. The second optimization button is configured for optimizing the game content corresponding to the second error location point. In some other aspects, the second optimization button is also referred to as a one-click optimization button.

In this aspect, the second optimization button is displayed in the peripheral region of the second error location point, so that after the player clicks the second optimization button, one-click optimization on the second error location point can be implemented. This improves overall optimization efficiency, reduces a quantity of operations of the player, and simplifies an optimization operation of the player, improving user experience.

### Optimization Process

In some aspects, after operation 280, the method further includes operation 292 and operation 294.

Operation 292: Trigger, in response to a trigger operation for the optimization button, optimization on the game content corresponding to the error location point.

The trigger operation is an operation for triggering the optimization button. In some aspects, the trigger operation includes at least one of a click, a double-click, a long-press, a touch, and a slide. For example, the computer device triggers, in response to the trigger operation for the optimization button, the AI model to optimize the game content corresponding to the error location point. The AI model used in the optimization process and the AI model used in the verification process may be a same AI model, or may be different AI models. This is not limited in this aspect.

Operation 294: Undisplay the error reporting prompt information in response to completion of optimization on the game content, and undisplay the optimization button.

When there is no error location point in the game level, the computer device does not need to display the error reporting prompt information and the optimization button. For example, the computer device undisplays the error reporting prompt information in response to completion of optimization on the game content, and undisplays the optimization button.

In this aspect, the error location point is optimized by using the AI model, so that the optimization intelligence and the optimization efficiency are improved, and optimization time is reduced. Undisplaying the error reporting prompt information and undisplaying the optimization button can further prompt the player that optimization is completed or optimization does not need to be continued.

In some aspects, during optimization in operation 292, the method further includes operation 293.

Operation 293: Display an optimization progress bar in a process of optimizing the game content corresponding to the error location point, the optimization progress bar being configured for indicating optimization progress of optimizing the game content corresponding to the error location point.

To enable the player to learn optimization progress of the game content of the game level, for example, the computer device displays the optimization progress bar in the process of optimizing the game content corresponding to the error location point. The optimization progress bar is configured for indicating the optimization progress of optimizing the game content corresponding to the error location point by the AI model.

In some aspects, the optimization progress bar may be converted from the optimization button, or the optimization progress bar may be another separately added display element. In some aspects, the optimization progress bar may be displayed in a peripheral region of the verification button, displayed in the peripheral region of the error location point, or displayed in the peripheral region of the first error location point. In some aspects, the verification button is displayed in an unclickable state in the process of optimizing the game content corresponding to the error location point. In this case, the player cannot trigger the verification button. When optimization is completed, the verification button is restored to a clickable state. In this case, the player may select, based on an actual need, whether to perform verification again.

In a possible implementation, still refer to FIG. 8. As shown in (2) in FIG. 8, in the process of optimizing the game content corresponding to the error location point, an optimization progress bar 50 is displayed in the peripheral region of the verification button. The optimization progress bar is configured for indicating the optimization progress of the game content corresponding to the error location point.

In this aspect, the optimization progress bar is displayed, so that the player can visually learn the optimization progress, improving participation of the player in the optimization process, and improving user experience.

### Determining of the Error Location Point

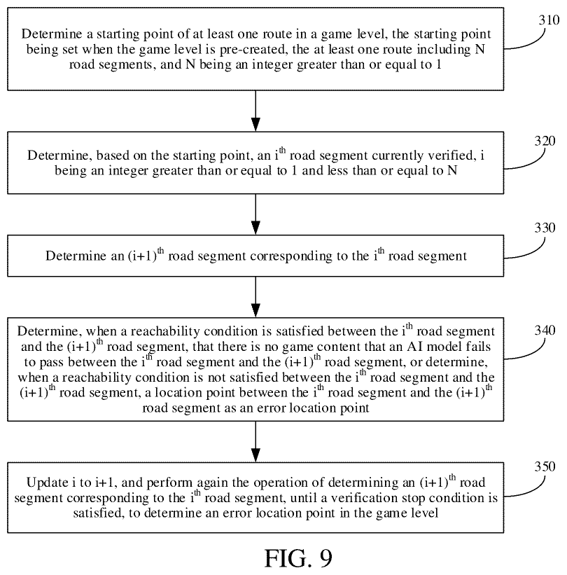

In some aspects, FIG. 9 is a flowchart of a game level verification method according to an illustrative aspect as described herein. An example in which the method is performed by the computer device shown in FIG. 1 is used for description. The computer device may be the terminal 120 shown in FIG. 1. The terminal 120 has the AI model stored therein. The method may be specifically performed by the AI model in the terminal 120. The method further includes all or a part of operation 310, operation 320, operation 330, operation 340, and operation 350.

Operation 310: Determine a starting point of the at least one route in the game level, the starting point being set when the game level is pre-created, the at least one route including N road segments, and N being an integer greater than or equal to 1.

In this aspect, it is set that the game level includes one starting point and one end point. Both the starting point and the end point are set when the game level is pre-created. There is the at least one route from the starting point and the end point. The at least one route includes the N road segments. N is an integer greater than or equal to 1.

For example, the computer device determines the starting point of the at least one route in the game level. In some aspects, a road segment on which the starting point is located is also referred to as a starting road segment.

Operation 320: Determine, based on the starting point, an i^{th} road segment currently verified, i being an integer greater than or equal to 1 and less than or equal to N.

For example, the computer device determines, based on the starting point, the i^{th} road segment currently verified, i being an integer greater than or equal to 1 and less than or equal to N. When current verification is first verification, the i^{th} road segment is the starting road segment on which the starting point is located. When current verification is second verification, an (i+1)^{th} road segment (a next road segment) corresponding to the i^{th} road segment (the starting road segment) during first verification is used as an i^{th} road segment.

Operation 330: Determine the (i+1)^{th} road segment corresponding to the i^{th} road segment.

For example, the computer device determines the (i+1)^{th} road segment corresponding to the i^{th} road segment. In the game level, the player needs to control the virtual object to reach the (i+1)^{th} road segment from the i^{th} road segment in at least one of the walking manner, the jumping manner, the climbing manner, and the falling manner. A manner for determining the (i+1)^{th} road segment is described in detail in subsequent aspects.

Operation 340: Determine, when a reachability condition is satisfied between the i^{th} road segment and the (i+1)^{th} road segment, that there is no game content that the AI model fails to pass between the i^{th} road segment and the (i+1)^{th} road segment, or determine, when a reachability condition is not satisfied between the i^{th} road segment and the (i+1)^{th} road segment, a location point between the i^{th} road segment and the (i+1)^{th} road segment as the error location point.

The reachability condition is a condition that needs to be satisfied by the AI model for reaching the (i+1)^{th} road segment from the i^{th} road segment. In this aspect, three reachability conditions are set, which are described in detail in subsequent aspects.

For example, the computer device determines, when the reachability condition is satisfied between the i^{th} road segment and the (i+1)^{th} road segment, that there is no game content that the AI model fails to pass between the i^{th} road segment and the (i+1)^{th} road segment. In this case, it may be determined that there is no error location point between the i^{th} road segment and the (i+1)^{th} road segment.

When the reachability condition is not satisfied between the i^{th} road segment and the (i+1)^{th} road segment, the computer device determines the location point between the i^{th} road segment and the (i+1)^{th} road segment as the error location point, and displays the error reporting prompt information at the error location point.

Operation 350: Update i to i+1, and perform again the operation of determining an (i+1)^{th} road segment corresponding to the i^{th} road segment, until a verification stop condition is satisfied, to determine the error location point in the game level.

For example, the computer device updates i to i+1, and performs operation 330 to operation 350 again, until the verification stop condition is satisfied, to determine the error location point in the game level. So far, the computer device determines and displays all error location points in the game level.

In some aspects, the verification stop condition includes at least one of the following: The N road segments of the at least one route are all traversed, the i^{th} road segment currently verified is a road segment on which an end point of the at least one route is located, there is no (i+1)^{th} road segment corresponding to the i^{th} road segment currently verified, and there is no error location point in the game level. The end point is set when the game level is pre-created.

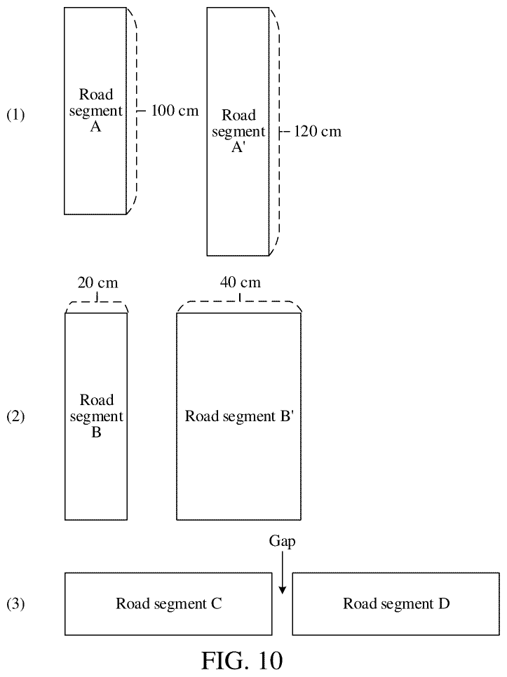

In a possible implementation, FIG. 10 is a schematic diagram of a game level verification method according to an illustrative aspect as described herein. An example in which the game level includes the at least one route and the at least one route includes a plurality of road segments is used. A road segment in the game level may be provided for a virtual object to walk, jump, climb, or fall, and the road segment may be stretched in length and/or width. As shown in (1) in FIG. 10, a length of a road segment A is 100 cm, and a length of a road segment A′ may be 120 cm after the road segment A is stretched in length. As shown in (2) in FIG. 10, a width of a road segment B is 20 cm, and a width of a road segment B′ may be 40 cm after the road segment B is stretched in width. As shown in (3) in FIG. 10, road segments are placed one by one, and there is a gap between a road segment C and a road segment D. If the virtual object controlled by the player falls into the gap, the virtual object dies. The player needs to control the virtual object to reach the road segment D from the road segment C in at least one of the walking manner, the jumping manner, the climbing manner, and the falling manner.

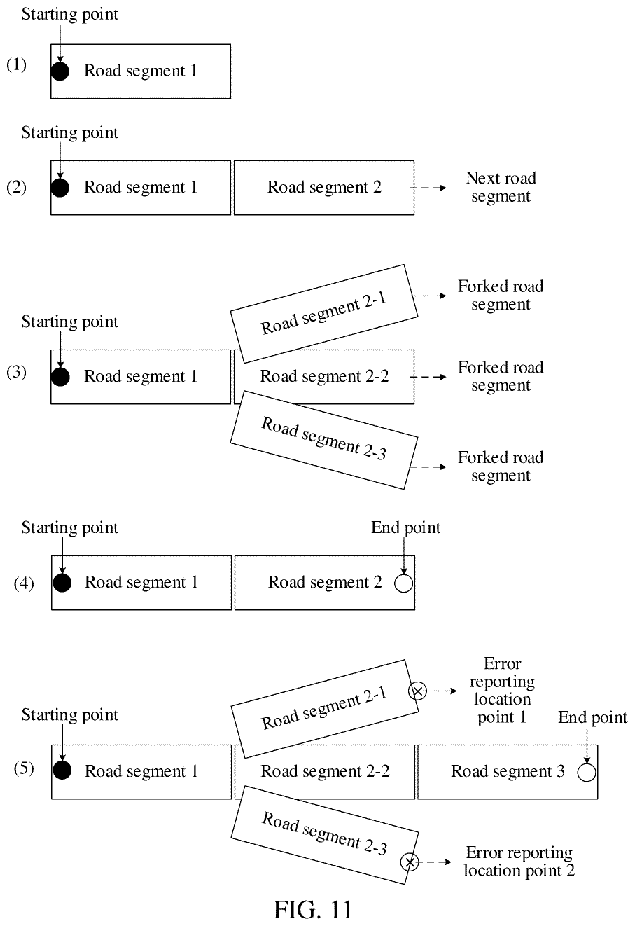

FIG. 11 is a schematic diagram of a game level verification method according to an illustrative aspect as described herein. As shown in (1) in FIG. 11, the computer device determines the starting point of the at least one route in the game level. A road segment 1 on which the starting point is located is also referred to as the starting road segment. The computer device emits rays from six surfaces, that is, a front surface, a rear surface, an upper surface, a lower surface, a left surface, and a right surface, of a road segment model corresponding to the road segment 1, to determine a next road segment corresponding to the road segment 1. As shown in (2) in FIG. 11, the road segment 1 may only correspond to a road segment 2. In this case, the computer device only needs to determine whether the reachability condition is satisfied between the road segment 1 and the road segment 2. As shown in (3) in FIG. 11, the road segment 1 may alternatively correspond to a road segment 2-1, a road segment 2-2, and a road segment 2-3. In this case, the computer device needs to separately determine whether the reachability condition is satisfied between the road segment 1 and the road segment 2-1, between the road segment 1 and the road segment 2-2, and between the road segment 1 and the road segment 2-3. As shown in (4) in FIG. 11, if the reachability condition is satisfied between the road segment 1 and the road segment 2, and the end point is located on the road segment 2, there is no error location point on the route. As shown in (5) in FIG. 11, if the reachability condition is satisfied between the road segment 1 and the road segment 2-2 and between the road segment 2-2 and the road segment 3, and the end point is located on the road segment 3, there is no error location point on the route. If the reachability condition is satisfied between the road segment 1 and the road segment 2-1, but there is no next road segment corresponding to the road segment 2-1, a road segment end point of the road segment 2-1 is determined as an error location point. If the reachability condition is satisfied between the road segment 1 and the road segment 2-3, but there is no next road segment corresponding to the road segment 2-3, a road segment end point of the road segment 2-3 is determined as an error location point. In this case, verification ends.

In this aspect, the road segment in the game level can be verified, so that accuracy of verifying the game level is improved, and effects of verifying the game level are improved.

### Road Segment Determining

In some aspects, operation 330 is implemented as operation 332 and operation 334.

Operation 332: Emit a ray in a preset direction by using a road segment model of the i^{th} road segment as an endpoint.

Operation 334: Determine, when the ray has an intersection with another road segment, the another road segment as the (i+1)^{th} road segment corresponding to the i^{th} road segment.

Because the at least one route in the game level includes the plurality of road segments, and the plurality of road segments include a common road segment and forked road segments, the i^{th} road segment may correspond to a plurality of (i+1)^{th} road segments. To determine all the (i+1)^{th} road segments corresponding to the i^{th} road segment, the (i+1)^{th} road segments may be determined by emitting rays.

For example, the computer device emits the ray in the preset direction by using the road segment model of the i^{th} road segment as the endpoint. The preset direction may include but is not limited to directions such as any upper, lower, left, right, and upper left angle, any lower left angle, any upper right angle, and any lower right angle. When the ray has the intersection with the another road segment, the another road segment is determined as the (i+1)^{th} road segment corresponding to the i^{th} road segment. A quantity of (i+1)^{th} road segments is greater than or equal to 1.

In this aspect, all next road segments of a current road segment can be determined, and omission of any road segment can be avoided, so that the accuracy of verifying the game level is improved.

### Reachability Condition Setting 1

In some aspects, it is set that the reachability condition includes a first reachability condition, and the i^{th} road segment and the (i+1)^{th} road segment are located on a same plane. In this case, the method further includes operation 411 and operation 412.

Operation 411: Determine a shortest distance between the i^{th} road segment and the (i+1)^{th} road segment.

Operation 412: Determine, when the shortest distance is less than or equal to a first set distance, that the first reachability condition is satisfied between the i^{th} road segment and the (i+1)^{th} road segment, the first set distance including at least one of a maximum walking step length and a maximum jump step length of the virtual object corresponding to the AI model, the maximum walking step length being a maximum distance between a walking starting point and a walking landing point, and the maximum jump step length being a maximum distance between a jump starting point and a jump landing point.

The shortest distance is a distance between two closest sides between the i^{th} road segment and the (i+1)^{th} road segment.

The first set distance is a preset distance threshold. The first set distance includes at least one of the maximum walking step length and the maximum jump step length of the virtual object corresponding to the AI model. The maximum walking step length is the maximum distance between the walking starting point and the walking landing point when the virtual object corresponding to the AI model travels in the walking manner. The maximum jump step length is the maximum distance between the jump starting point and the jump landing point when the virtual object corresponding to the AI model travels in the jumping manner. In an example, the maximum walking step length is set to 50 cm, and the maximum jump step length is set to 2 m.

For example, the computer device determines the shortest distance between the i^{th} road segment and the (i+1)^{th} road segment; and determines, when the shortest distance is less than or equal to a first set distance, that the first reachability condition is satisfied between the i^{th} road segment and the (i+1)^{th} road segment.

In an example, when the i^{th} road segment and the (i+1)^{th} road segment are located on the same plane, and the shortest distance between the i^{th} road segment and the (i+1)^{th} road segment is less than 2 m, the virtual object corresponding to the AI model can reach the (i+1)^{th} road segment from the i^{th} road segment in the jumping manner, and the first reachability condition is satisfied between the i^{th} road segment and the (i+1)^{th} road segment.

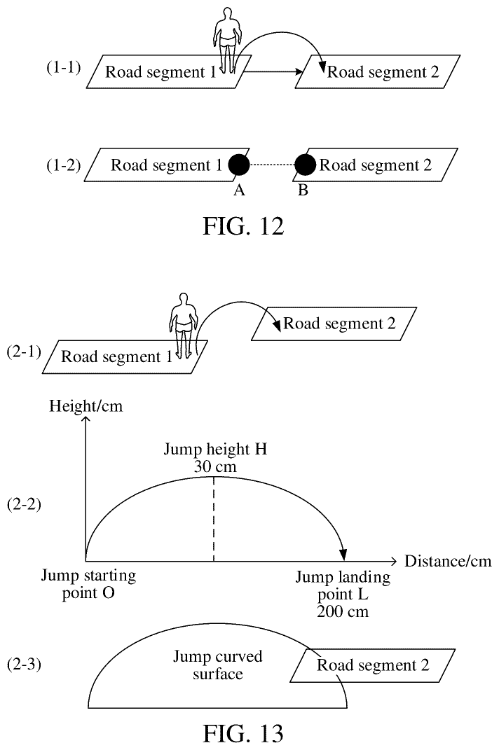

In a possible implementation, FIG. 12 is a schematic diagram of a game level verification method according to an illustrative aspect as described herein. As shown in (1-1) in FIG. 12, the road segment 1 and the road segment 2 are located on a same plane, and the virtual object corresponding to the AI model needs to reach the road segment 2 from the road segment 1 in the walking manner or the jumping manner. As shown in (1-2) in FIG. 12, the computer device determines a shortest distance AB between the road segment 1 and the road segment 2, and determines, when the shortest distance AB is less than or equal to 2 m, that the first reachability condition is satisfied between the road segment 1 and the road segment 2, or determines, when the shortest distance AB is not less than or equal to 2 m, a location point between the road segment 1 and the road segment 2 as an error location point.

### Reachability Condition Setting 2

In some aspects, the reachability condition includes a second reachability condition, and the i^{th} road segment and the (i+1)^{th} road segment are located on different planes, where the i^{th} road segment is located on a first plane, the (i+1)^{th} road segment is located on a second plane, and the first plane is lower than the second plane. The method further includes operation 421, operation 422, operation 423, and operation 424.

Operation 421: Determine a jump starting point of the virtual object corresponding to the AI model on the i^{th} road segment.

Operation 422: Determine a plurality of jump curves based on the jump starting point and a jump height of the virtual object.

Operation 423: Determine a jump curved surface based on the plurality of jump curves.

Operation 424: Determine, when the second plane corresponding to the (i+1)^{th} road segment has an intersection with the jump curved surface, that the second reachability condition is satisfied between the i^{th} road segment and the (i+1)^{th} road segment.

The jump starting point is a location point at which the virtual object performs a jump on the i^{th} road segment when the virtual object corresponding to the AI model travels from the i^{th} road segment to the (i+1)^{th} road segment in the jumping manner.

The jump height is a preset height. The jump height may be set based on the types of the game, the game level, and the game content, or a player level of the creator of the game level. In an example, a maximum value of the jump height is 30 cm.

The jump curve is a curve between the jump starting point and the jump landing point, that is, a jump trajectory formed when the virtual object jumps. The jump curve is a parabola. In an example, a maximum distance between the jump landing point and the jump starting point is 2 m. A coordinate system is established by using a distance/cm as a horizontal axis and a height/cm as a vertical axis. In this case, the jump starting point is (0, 0), the jump landing point is (0, 200), and a maximum jump point corresponding to a maximum jump height is (100, 30).

The jump curved surface is determined based on the plurality of jump curves. Because the virtual object corresponding to the AI model may jump to a preset angle (for example, 360°) around the i^{th} road segment, and each direction corresponds to one jump curve, the plurality of jump curves may form the jump curved surface. When the second plane corresponding to the (i+1)^{th} road segment has the intersection with the jump curved surface, it is determined that the virtual object corresponding to the AI model can reach the (i+1)^{th} road segment from the i^{th} road segment in the jumping manner or can reach the (i+1)^{th} road segment from the i^{th} road segment in a manner of jumping and then climbing.

For example, the computer device determines the jump starting point of the virtual object on the i^{th} road segment, determines the plurality of jump curves based on the jump starting point and the jump height of the virtual object, determines the jump curved surface based on the plurality of jump curves, and determines, when the second plane corresponding to the (i+1)^{th} road segment has the intersection with the jump curved surface, that the second reachability condition is satisfied between the i^{th} road segment and the (i+1)^{th} road segment.

In a possible implementation, FIG. 13 is a schematic diagram of a game level verification method according to an illustrative aspect as described herein. As shown in (2-1) in FIG. 13, the road segment 1 and the road segment 2 are located on different planes, where the road segment 1 is located on the first plane, the road segment 2 is located on the second plane, and the first plane is lower than the second plane. The virtual object corresponding to the AI model needs to reach the road segment 2 from the road segment 1 in the jumping manner. As shown in (2-2) in FIG. 13, the computer device determines a jump curve based on a jump starting point O and a jump height H. The jump curve is a parabola. A maximum distance between a jump landing point and the jump starting point is 2 m. A coordinate system is established by using the distance/cm as a horizontal axis and a height/cm as a vertical axis. In this case, the jump starting point O is (0, 0), the jump landing point L is (0, 200), and a maximum jump point H corresponding to a maximum jump height is (100, 30). As shown in (2-3) in FIG. 13, the computer device determines a jump curved surface based on the plurality of jump curves, and determines, when the second plane corresponding to the road segment 2 has an intersection with the jump curved surface, that the second reachability condition is satisfied between the road segment 1 and the road segment 2, or determines, when the second plane corresponding to the road segment 2 has no intersection with the jump curved surface, a location point between the road segment 1 and the road segment 2 as an error location point.

### Reachability Condition Setting 3

In some aspects, the reachability condition includes a third reachability condition, and the i^{th} road segment and the (i+1)^{th} road segment are located on different planes, where the i^{th} road segment is located on a first plane, the (i+1)^{th} road segment is located on a second plane, and the first plane is higher than the second plane. The method further includes operation 431, operation 432, and operation 433.

Operation 431: Determine a falling point of the virtual object corresponding to the AI model, the falling point being a starting location point of a free fall motion of the virtual object.

Operation 432: Determine a preset side of the (i+1)^{th} road segment that is closest to the i^{th} road segment.

Operation 433: Determine, when a distance between the preset side and a free fall route of the virtual object is less than or equal to a second set distance, that the third reachability condition is satisfied between the i^{th} road segment and the (i+1)^{th} road segment, the second set distance being determined based on a model width of the virtual object.

The falling point is a location point at which the virtual object corresponding to the AI model starts to fall. The virtual object performs the free fall motion from the falling point. The falling point is also referred to as a starting location point of the free fall motion of the virtual object. A manner for determining the falling point is described in detail in subsequent aspects.

The preset side is a side on the (i+1)^{th} road segment that is closest to the i^{th} road segment. Specifically, based on a location relationship between the i^{th} road segment and the (i+1)^{th} road segment, the preset side may be a long side of the (i+1)^{th} road segment, or may be a short side of the (i+1)^{th} road segment.

The second set distance is a preset distance threshold. Because the virtual object corresponding to the AI model is a three-dimensional model in the virtual environment, the virtual object has a specific model width. Therefore, the second set distance may be determined based on the model width of the virtual object. In some aspects, the second set distance is a half of the model width. When the distance between the preset side and the free fall route of the virtual object is less than or equal to the second set distance, it is determined that the virtual object corresponding to the AI model can reach the (i+1)^{th} road segment from the i^{th} road segment in the falling manner.

For example, the computer device determines the falling point of the virtual object, determines the preset side of the (i+1)^{th} road segment that is closest to the i^{th} road segment, and determines, when the distance between the preset side and the free fall route of the virtual object is less than or equal to the second set distance, that the third reachability condition is satisfied between the i^{th} road segment and the (i+1)^{th} road segment.

In some aspects, there are two manners for determining the falling point. During an actual application, any one manner may be selected, or the two manners may be combined for use.

Manner 1: Operation 431 is implemented as operation 431-11 and 431-12. Manner 2: Operation 431 is implemented as operation 431-21, operation 431-22, operation 431-23, and operation 431-24.

Operation 431-11: Determine a movement speed of the virtual object on the i^{th} road segment.

Operation 431-12: Determine a location point corresponding to reduction of the movement speed to 0 as the falling point.

When the virtual object corresponding to the AI model travels from the i^{th} road segment to the (i+1)^{th} road segment in the walking manner, the virtual object has a specific movement speed. When a current location of the virtual object exceeds a road segment end point of the i^{th} road segment, the movement speed is gradually reduced to 0, and then the virtual object starts to fall.

For example, the computer device determines the movement speed of the virtual object on the i^{th} road segment, and determines the location point corresponding to reduction of the movement speed to 0 as the falling point. In an example, the road segment end point corresponding to the i^{th} road segment is set to (0, 0), and the location point corresponding to reduction of the movement speed of the virtual object on the i^{th} road segment to 0 is (0, 10). In this case, the falling point is farthest (0, 10). In other wise, when the virtual object leaves the i^{th} road segment and is in a suspended state, the movement speed is reduced to 0.

Step 431-21: Determine a jump starting point of the virtual object on the i^{th} road segment.

Step 431-22: Determine a plurality of jump curves based on the jump starting point and a jump height of the virtual object.

Step 431-23: Determine a jump curved surface based on the plurality of jump curves.

Step 431-24: Determine an intersection point between the jump curved surface and the first plane as the falling point.

When the virtual object corresponding to the AI model travels from the i^{th} road segment to the (i+1)^{th} road segment in the jumping manner, the virtual object may jump 360° around the i^{th} road segment. The jump curve between the jump starting point and a jump landing point is a parabola. If the virtual object does not reach the (i+1)^{th} road segment at a farthest jump landing point, the virtual object starts to fall freely. Both the jump landing point and the jump starting point are located on the first plane on which the i^{th} road segment is located.

For example, the computer device determines the jump starting point of the virtual object on the i^{th} road segment, determines the plurality of jump curves based on the jump starting point and the jump height of the virtual object, determines the jump curved surface based on the plurality of jump curves, and determines the intersection point between the jump curved surface and the first plane as the falling point.

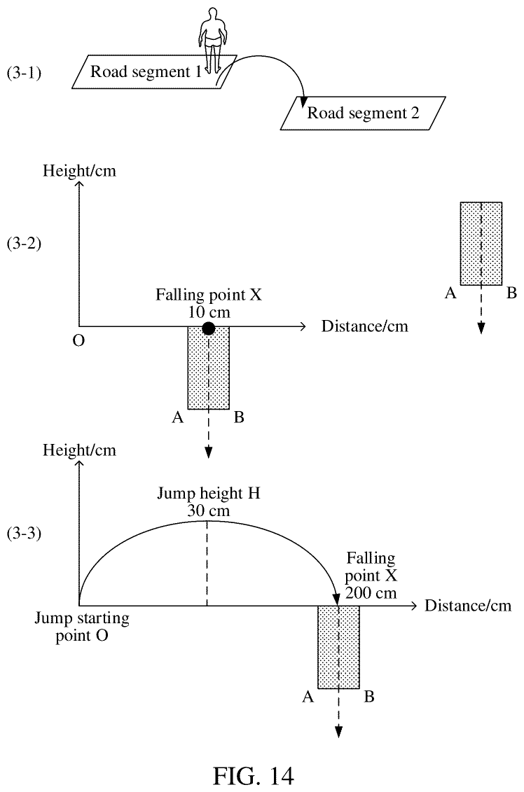

In a possible implementation, FIG. 14 is a schematic diagram of a game level verification method according to an illustrative aspect as described herein. As shown in (3-1) in FIG. 14, the road segment 1 and the road segment 2 are located on different planes, where the road segment 1 is located on the first plane, the road segment 2 is located on the second plane, and the first plane is higher than the second plane. The virtual object corresponding to the AI model needs to reach the road segment 2 from the road segment 1 in the falling manner, in a manner of walking and then falling, or in a manner of jumping and then falling. As shown in (3-2) in FIG. 14, the computer device establishes a coordinate system by using a distance/cm as a horizontal axis and a height/cm as a vertical axis. In this case, a road segment end point O of the road segment 1 is (0, 0). A walking speed of the virtual object is reduced to 0 when the virtual object travels to a falling point X, and then the virtual object starts to fall from the falling point X (0, 10). A dashed arrow is the free fall route of the virtual object. The free fall route may be extended downward infinitely or to a set length. Because the virtual object has a model width AB, and the model width AB is set to 40 cm, when a distance between a preset side of the road segment 2 that is closest to the road segment 1 and the free fall route of the virtual object is less than or equal to 20 cm, the virtual object may fall onto the road segment 2. In this case, the computer device may determine that the third reachability condition is satisfied between the road segment 1 and the road segment 2. As shown in (3-3) in FIG. 14, the computer device determines a jump curve based on the jump starting point O and the jump height H. The jump curve is a parabola. A maximum value of the jump landing point is 2 m, so that the jump landing point is (0, 200). The jump landing point is the falling point X. The virtual object starts to fall from the falling point X. A dashed arrow is the free fall route of the virtual object. The free fall route may be extended downward infinitely or to a set length. Because the virtual object has the model width AB, and the model width AB is set to 40 cm, when the distance between the preset side of the road segment 2 that is closest to the road segment 1 and the free fall route of the virtual object is less than or equal to 20 cm, the virtual object may fall onto the road segment 2. In this case, the computer device determines that the third reachability condition is satisfied between the road segment 1 and the road segment 2. When the distance between the preset side of the road segment 2 that is closest to the road segment 1 and the free fall route of the virtual object is not less than or equal to 20 cm, the computer device determines a location point between the road segment 1 and the road segment 2 as an error location point.

In the foregoing aspect, a plurality of reachability conditions are provided. During an actual application, the computer device may determine, based on a specific location relationship between two road segments, to use one or more of the reachability conditions to verify whether the reachability condition is satisfied between the two road segments. This improves flexibility and pertinence of verifying the game level, improving accuracy and effects of verifying the game level.

### Optimization Manner

In some aspects, the AI model may optimize the game content. In this case, the method further includes operation 510.

Step 510: Trigger, based on the type of the error location point, optimization on the game content corresponding to the error location point.

When the reachability condition is not satisfied between the i^{th} road segment and the (i+1)^{th} road segment, the location point between the i^{th} road segment and the (i+1)^{th} road segment is determined as the error location point. There are set three reachability conditions. Therefore, there may be three types of error location points. Correspondingly, there may be three optimization manners for the game content. For example, the computer device may trigger, based on the type of the error location point, the AI model to optimize the game content corresponding to the error location point.

In some aspects, the optimization button is the first optimization button, and when the first error location point is selected, the computer device triggers, based on a type of the first error location point, the AI model to optimize the game content corresponding to the error location point. Alternatively, the optimization button is the second optimization button, and the computer device triggers, based on a sequence of appearance of error reporting prompt information at each error location point or based on a distance between the error location point and the virtual object corresponding to the creator, the AI model to sequentially optimize game content corresponding to each error location point.

In this aspect, triggering, based on the type of the error location point, the AI model to optimize the game content corresponding to the error location point can enable the AI model to pertinently optimize the error location point, improving optimization flexibility and pertinence, and improving the optimization efficiency and the optimization effects.

Specifically, the error location point is a location point between the i^{th} road segment and the (i+1)^{th} road segment on the at least one route of the game level. Any one or more of the following optimization manners may be performed.

### Optimization Manner 1

In some aspects, operation 520 is implemented as operation 521 and operation 522.

Operation 521: Determine the preset side of the (i+1)^{th} road segment that is closest to the i^{th} road segment.

Step 522: Pull the preset side based on a direction of the i^{th} road segment, to stretch the (i+1)^{th} road segment by a first length, so that the first reachability condition is satisfied between the i^{th} road segment and the (i+1)^{th} road segment.

In this aspect, when the error location point is a location point at which the first reachability condition is not satisfied, the computer device may determine the preset side of the (i+1)^{th} road segment that is closest to the i^{th} road segment, and pull the preset side in a direction approaching the i^{th} road segment based on the direction of the i^{th} road segment, to stretch the (i+1)^{th} road segment by the first length, so that the first reachability condition is satisfied between the i^{th} road segment and the (i+1)^{th} road segment.

In a possible example, when the shortest distance between the i^{th} road segment and the (i+1)^{th} road segment is less than or equal to the first set distance, it is determined that the first reachability condition is satisfied between the i^{th} road segment and the (i+1)^{th} road segment. The preset side of the (i+1)^{th} road segment is pulled to stretch the (i+1)^{th} road segment by the first length, so that the first reachability condition is satisfied between the i^{th} road segment and the (i+1)^{th} road segment.

### Optimization Manner 2

In some aspects, operation 520 is implemented as operation 521 and operation 523.

Operation 521: Determine the preset side of the (i+1)^{th} road segment that is closest to the i^{th} road segment.

Step 523: Pull the preset side based on a direction of the i^{th} road segment, to stretch the (i+1)^{th} road segment by a second length, and translate the (i+1)^{th} road segment by a third length based on a vertical axis, so that the second reachability condition is satisfied between the i^{th} road segment and the (i+1)^{th} road segment.

In this aspect, when the error location point is a location point at which the second reachability condition is not satisfied, the computer device determines the preset side of the (i+1)^{th} road segment that is closest to the i^{th} road segment, and pulls the preset side in a direction approaching the i^{th} road segment based on the direction of the i^{th} road segment, to stretch the (i+1)^{th} road segment by the second length, so that the second reachability condition is satisfied between the i^{th} road segment and the (i+1)^{th} road segment. In addition, when the second reachability condition cannot be satisfied after pulling, the (i+1)^{th} road segment is translated in a direction approaching the i^{th} road segment by the third length based on the vertical axis, so that the second reachability condition is satisfied between the i^{th} road segment and the (i+1)^{th} road segment.

In a possible example, when the second plane corresponding to the (i+1)^{th} road segment has the intersection with the jump curved surface, it is determined that the second reachability condition is satisfied between the i^{th} road segment and the (i+1)^{th} road segment. The preset side of the (i+1)^{th} road segment is pulled, and/or the (i+1)^{th} road segment is translated by the third length based on the vertical axis, so that the second reachability condition is satisfied between the i^{th} road segment and the (i+1)^{th} road segment.

### Optimization Manner 3

In some aspects, operation 520 is implemented as operation 521 and operation 524.

Operation 521: Determine the preset side of the (i+1)^{th} road segment that is closest to the i^{th} road segment.

Step 524: Pull the preset side based on a direction of the i^{th} road segment, to stretch the (i+1)^{th} road segment by a fourth length, so that the third reachability condition is satisfied between the i^{th} road segment and the (i+1)^{th} road segment.

In this aspect, when the error location point is a location point at which the third reachability condition is not satisfied, the computer device determines the preset side of the (i+1)^{th} road segment that is closest to the i^{th} road segment, and pulls the preset side in a direction approaching the i^{th} road segment based on the direction of the i^{th} road segment, to stretch the (i+1)^{th} road segment by the fourth length, so that the third reachability condition is satisfied between the i^{th} road segment and the (i+1)^{th} road segment.

In a possible example, when the distance between the preset side and the free fall route of the virtual object is less than or equal to the second set distance, it is determined that the third reachability condition is satisfied between the i^{th} road segment and the (i+1)^{th} road segment. The preset side of the (i+1)^{th} road segment is pulled, so that the third reachability condition is satisfied between the i^{th} road segment and the (i+1)^{th} road segment.

In the foregoing aspect, based on the location relationship between the i^{th} road segment and the (i+1)^{th} road segment, the preset side may be the long side of the (i+1)^{th} road segment, or may be the short side of the (i+1)^{th} road segment. For example, if a short side of the road segment 1 is closest to a short side of the road segment 2, the short side of the road segment 2 is stretched, equivalent to increasing a length of the road segment 2; or if a short side of the road segment 1 is closest to a long side of the road segment 2, the long side of the road segment 2 is stretched, equivalent to increasing a width of the road segment 2. In other words, the long side of the (i+1)^{th} road segment may be pulled to increase a width of the (i+1)^{th} road segment, the short side of the (i+1)^{th} road segment may be pulled to increase a length of the (i+1)^{th} road segment, or both the long side and the short side of the (i+1)^{th} road segment may be pulled to increase a width and a length of the (i+1)^{th} road segment, so that at least one reachability condition is satisfied between the i^{th} road segment and the (i+1)^{th} road segment, implementing optimization on the error location point between the i^{th} road segment and the (i+1)^{th} road segment.

In the foregoing aspect, a plurality of optimization manners are provided. During an actual application, the computer device may determine, based on a specific location relationship between two road segments and a reachability condition that needs to be satisfied between the two road segments, to use one or more of the optimization manners to optimize the error location point. This improves flexibility and pertinence of optimizing the game level, improving the optimization efficiency and the optimization effects.

In the following aspect, an example in which a computer device performs a game level verification method and the computer device is the terminal 120 shown in FIG. 1 is used to separately describe, with reference to the schematic diagrams and the flowcharts, an interface side and a background side in the game level verification method provided in this aspect. The terminal 120 has an AI model stored therein. A game level can be verified and optimized by using the AI model.

### Interface Side

1: As shown in (1) in FIG. 5, an AI verification button 10 is added to an upper display region of a game level screen (a UGC main interface). As shown in (2) in FIG. 5, the AI verification button 10 is displayed in a normal state 11 before being triggered. When a player clicks the AI verification button 10, the function is activated, and the AI verification button 10 is displayed in an in-progress state 12. After verification is completed, the AI verification button 10 is displayed in a complete state 13. In this case, the AI verification button 10 is restored to the normal state. If there is an error location point in the game level, a one-click optimization button is added to a display region on the right of the AI verification button 10.

2: As shown in FIG. 6, after the player clicks the AI verification button 10, a virtual object 20 corresponding to the AI model appears at a starting point of the game level. The virtual object 20 corresponding to the AI model performs verification along at least one route from the starting point to an end point. When the at least one route includes forked road segments 22, a corresponding quantity of AI models 23 are added based on a quantity of the forked road segments 22, and verification continues along a corresponding road segment. When the forked road segments 22 of the at least one route are merged again into one common road segment, a corresponding quantity of AI models 23 are merged into one AI model.

3: As shown in FIG. 7, in a verification process, there are several cases in the game level: a distance is too long to jump or walk across, a height is too large to jump or climb over, and a landing point is too far to jump and fall onto. Error reporting prompt information may be displayed at a corresponding error location point in the game level. The error reporting prompt information includes an error reporting prompt element 31 and a corresponding error reporting prompt text.

4: As shown in (1) in FIG. 8, after verification is completed, the player may aim at a selected region in the game level with a crosshair. The selected region includes an error location point 41, and an intelligent optimization button is displayed on the right of the error location point 41. If the selected region includes a plurality of error location points, a closest error location point is selected. After the player clicks the intelligent optimization button, the computer device optimizes, by using the AI model, game content corresponding to the error location point. As shown in (2) in FIG. 8, in an optimization process, the intelligent optimization button becomes a progress bar indicating optimization progress, and the AI verification button 10 is displayed in gray. In this case, the player cannot click the button until optimization on the error location point is completed. When optimization is completed, the error reporting prompt information corresponding to the error location point is hidden.

5: After verification is completed, when the player clicks a one-click optimization button, the computer device sequentially optimizes, based on a sequence of appearance of error reporting prompt information or based on an order of error location points sorted by their distances to the creator's virtual object, game content corresponding to each error location point using an AI model. As shown in (2) in FIG. 8, in an optimization process, the one-click optimization button becomes a progress bar indicating optimization progress, and the AI verification button 10 is displayed in gray. In this case, the player cannot click the button until optimization on all error location points is completed. When optimization is completed, error reporting prompt information corresponding to all the error location points is hidden.

Operation 4 and operation 5 may be parallel operations, or operation 4 may be performed before operation 5. This is not limited in this aspect.

### Background Side

### Verification Process

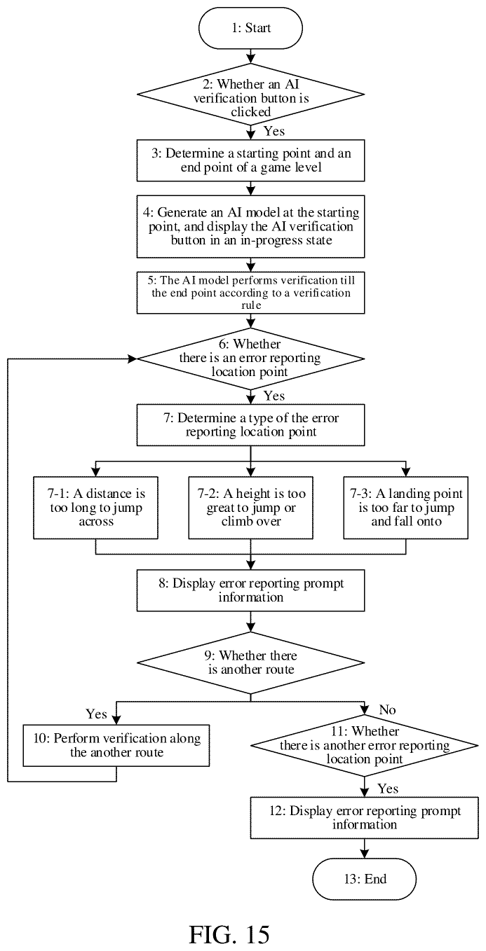

FIG. 15 is a flowchart of a game level verification method according to an illustrative aspect as described herein. Operations of the verification process in the game level verification method performed by the computer device are as follows.

1: Start.

2: Determine whether the player clicks the AI verification button. If the player clicks the AI verification button, operation 3 is performed; or if the player does not click the AI verification button, no operation is performed.

3: Determine the starting point and the end point of the game level.

4: Generate an AI model at the starting point, and display the AI verification button in the in-progress state. The AI model is displayed as a virtual object in a demo screen. The virtual object is consistent with another virtual object in the game, and also supports walking, jumping, running, climbing, falling, and the like.

5: The AI model performs verification from the starting point to the end point in a preset verification manner. In this operation, a verification manner used when two road segments are on a same plane is different from that used when the two road segments are on different planes. There are three verification manners in total. For details, refer to the operations in the foregoing aspects. The details are not described herein again.

6: In a verification process, the AI model determines whether there is an error location point in the game level.

7: Determine a type of the error location point, the type including: 7-1: a distance between two road segments is too long to jump across; 7-2: a height between two road segments is too great to jump or climb over; and 7-3: a landing point between two road segments is too far to jump and fall onto.

8: Display, at the error location point, error reporting prompt information corresponding to the type of the error location point.

9: Continue to determine whether there is another route in the game level. If there is the another route in the game level, 10 is performed; or if there is not the another route in the game level, 11 is performed.

10: Perform verification along the another route. The manner in operation 5 is still used for verification.

11: Determine whether there is another error location point not displayed in this verification process. If there is the another error location point not displayed in this verification process, 12 is performed.

12: Display error reporting prompt information of the another error location point.

13: End. The AI verification button is restored to the normal state.

### Optimization Process

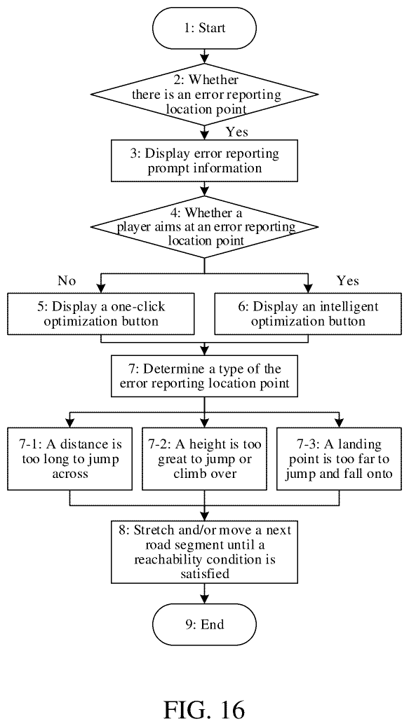

FIG. 16 is a flowchart of a game level verification method according to an illustrative aspect as described herein. During or after execution of the verification process of the computer device, operations of the optimization process in the game level verification method performed by the computer device are as follows.

1: Start.

2: Determine whether there is an error location point. If there is the error location point, operation 3 is performed.

3: Display error reporting prompt information at the error location point.

4: Determine whether the player aims at an error location point with the crosshair. If the player aims at the error location point with the crosshair, operation 6 is performed; or if the player does not aim at the error location point with the crosshair, operation 5 is performed.

5: Display a one-click optimization button on the right of the AI verification button.

6: Display an intelligent optimization button on the right of the error location point at which the crosshair aims.

7: Determine a type of the error location point, the type including: 7-1: a distance between two road segments is too long to jump across; 7-2: a height between two road segments is too great to jump or climb over; and 7-3: a landing point between two road segments is too far to jump and fall onto.

8: Stretch and/or move a next road segment corresponding to a current road segment until a reachability condition is satisfied between the two road segments. Specifically, if the type of the error location point is 7-1, that is, a distance between two road segments is too long to jump across, a preset side of the next road segment that is closest to the current road segment is stretched, so that a shortest distance between the two road segments is less than 2 m. If the type of the error location point is 7-2, that is, a height between two road segments is too great to jump or climb over, whether the next road segment can have an intersection with a jump curved surface after being stretched is determined; and if the next road segment can have the intersection with the jump curved surface after being stretched, a preset side of the next road segment that is closest to the current road segment is stretched, so that the stretched next road segment has an intersection with the jump curved surface; or if the next road segment cannot have the intersection with the jump curved surface after being stretched, after stretching, the stretched next road segment further needs to be moved based on a Z axis, so that the moved and stretched next road segment has an intersection with the jump curved surface. If the type of the error location point is 7-3, that is, a landing point between two road segments is too far to jump and fall onto, the next road segment is stretched, so that the stretched next road segment has an intersection with a jump curved surface. For details of this operation, refer to the operations in the foregoing aspects. The details are not described herein again.

9: End. After all error location points are optimized, the error reporting prompt information, the intelligent optimization button, and the one-click optimization button are undisplayed.

In summary, the game level verification method provided in this aspect may have the following beneficial effects.

1: The AI verification button is displayed, and after the player clicks the AI verification button, the player may verify the game level by using the AI model during creation of the game level and after creation of the game level, so that efficiency of creating the game level is improved, and playability of UGC creation gameplay is improved.

2: The game level is verified by using the AI model, and the AI model can verify each route of the game level, without a need for the player to perform any operation, so that a large amount of time is saved for the player.

3: The error reporting prompt information is displayed, so that the location and the type of the error location point can be clearly prompted, improving accuracy and efficiency of verifying the game level, and helping the player perform subsequent manual modification or optimization with the AI model.

4: The optimization button is displayed, and after the player clicks the optimization button, the AI model may automatically optimize the game content corresponding to the error location point, so that the optimization intelligence and the optimization efficiency are improved, and the optimization time is reduced.

5: The player does not need to spend a large amount of time on verifying appropriateness of the game level, and can focus on creating the game level more, so that quality of the game level created in the UGC creation gameplay is improved, and playability, flexibility, and openness of the game are improved.
6: Based on the foregoing beneficial effects, because the player only needs to click the AI verification button and the optimization button for the verification process and the optimization process, an interaction manner is simple, and other complex operations and understanding are not needed. Therefore, learning costs of the player can be maximally reduced, the efficiency and the effects of verifying the game level are improved, and the efficiency and the effects of optimizing the game level are improved, improving user experience.

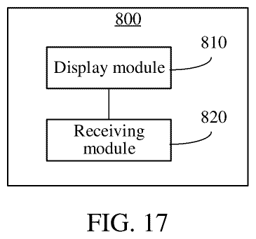

FIG. 17 is a block diagram of a game level verification apparatus 800 according to an illustrative aspect as described herein. The game level verification apparatus 800 includes:

a display module 810, configured to display a game level screen, the game level screen including a virtual environment corresponding to a pre-created game level; and

a receiving module 820, configured to receive a verification operation triggered for the game level, the verification operation being configured for triggering an AI model to verify game content of the game level.

The display module 810 is further configured to display error reporting prompt information of the game level in response to the verification operation, the error reporting prompt information being configured for prompting existence of an error location point in the game level, and the error location point being a location point corresponding to game content that the AI model fails to pass in the virtual environment.

In some aspects, the display module 810 is configured to:

display a demo screen in response to the verification operation, the demo screen being a screen for watching a demo of the game content of the game level by a virtual object, and the virtual object being a visual model corresponding to the AI model in the game level; and

display the error reporting prompt information on the demo screen.

In some aspects, the error reporting prompt information includes an error reporting prompt element.

In some aspects, the display module 810 is configured to:

display the error reporting prompt element at the error location point in the demo screen,

the error reporting prompt element being configured for prompting that a current location point is the error location point.

In some aspects, the error reporting prompt information includes an error reporting prompt text.

In some aspects, the display module 810 is configured to:

displaying the error reporting prompt text in a text display region in the demo screen,

the error reporting prompt text being configured for indicating a type of the error location point, and the type including failing to pass the error location point in at least one of a walking manner, a jumping manner, a climbing manner, or a falling manner.

In some aspects, there is at least one virtual object, the at least one virtual object is controlled by the AI model, and the game level includes at least one route.

In some aspects, the display module 810 is configured to:

display, in response to the verification operation, the demo screen in which the at least one virtual object travels along the at least one route.

In some aspects, the at least one virtual object includes a first virtual object and a second virtual object, and the second virtual object is obtained by duplicating the first virtual object.

The at least one route includes at least one common road segment and at least two forked road segments. There is at least one first virtual object on the at least one common road segment. There is at least one second virtual object on each of the at least two forked road segments. A quantity of the second virtual objects corresponds to a quantity of the at least two forked road segments.

In some aspects, the display module 810 is configured to:

display an optimization button based on a location of the error location point,

the optimization button being configured for triggering optimization on the game content corresponding to the error location point.

In some aspects, the display module 810 is configured to:

display, in response to a location point selection operation triggered based on the error location point, a first optimization button based on a location of a first error location point indicated by the location point selection operation,

the location point selection operation being configured for selecting the first error location point from the error location point, the optimization button including the first optimization button, and the first optimization button being configured for triggering optimization on game content corresponding to the first error location point.

In some aspects, the display module 810 is configured to:

display a second optimization button based on the location of the error location point,

the optimization button including the second optimization button, the second optimization button being configured for optimizing game content corresponding to a second error location point, and the second error location point being all or at least a part of the error location point, or the second error location point being all or at least a part of error location points other than the first error location point.

In some aspects, the display module 810 is configured to:

trigger, in response to a trigger operation for the optimization button, optimization on the game content corresponding to the error location point; and

undisplay the error reporting prompt information in response to completion of optimization on the game content, and undisplay the optimization button.

In some aspects, the display module 810 is configured to:

display an optimization progress bar in a process of optimizing the game content corresponding to the error location point,

the optimization progress bar being configured for indicating optimization progress of optimizing the game content corresponding to the error location point.

In some aspects, the apparatus further includes a processing module. The processing module is configured to:

the method further includes:

determine a starting point of the at least one route in the game level, the starting point being set when the game level is pre-created, the at least one route including N road segments, and N being an integer greater than or equal to 1;

determine, based on the starting point, an i^{th} road segment currently verified, i being an integer greater than or equal to 1 and less than or equal to N;

determine an (i+1)^{th} road segment corresponding to the i^{th} road segment;

determine, when a reachability condition is satisfied between the i^{th} road segment and the (i+1)^{th} road segment, that there is no game content that the AI model fails to pass between the i^{th} road segment and the (i+1)^{th} road segment, or determine, when a reachability condition is not satisfied between the i^{th} road segment and the (i+1)^{th} road segment, a location point between the i^{th} road segment and the (i+1)^{th} road segment as an error location point; and

update i to i+1, and perform again the operation of determining an (i+1)^{th} road segment corresponding to the i^{th} road segment, until a verification stop condition is satisfied, to determine the error location point in the game level.

In some aspects, the processing module is configured to:

emit a ray in a preset direction by using a road segment model of the i^{th} road segment as an endpoint; and

determine, when the ray has an intersection with another road segment, the another road segment as the (i+1)^{th} road segment corresponding to the i^{th} road segment.

In some aspects, the reachability condition includes a first reachability condition, and the i^{th} road segment and the (i+1)^{th} road segment are located on a same plane.

In some aspects, the processing module is configured to:

determine a shortest distance between the i^{th} road segment and the (i+1)^{th} road segment; and

determine, when the shortest distance is less than or equal to a first set distance, that the first reachability condition is satisfied between the i^{th} road segment and the (i+1)^{th} road segment,

the first set distance including at least one of a maximum walking step length and a maximum jump step length of the virtual object corresponding to the AI model, the maximum walking step length being a maximum distance between a walking starting point and a walking landing point, and the maximum jump step length being a maximum distance between a jump starting point and a jump landing point.

In some aspects, the reachability condition includes a second reachability condition, the i^{th} road segment is located on a first plane, the (i+1)^{th} road segment is located on a second plane, and the first plane is lower than the second plane.

In some aspects, the processing module is configured to:

determine a jump starting point of the virtual object corresponding to the AI model on the i^{th} road segment;

determine a plurality of jump curves based on the jump starting point and a jump height of the virtual object;

determine a jump curved surface based on the plurality of jump curves; and

determine, when the second plane corresponding to the (i+1)^{th} road segment has an intersection with the jump curved surface, that the second reachability condition is satisfied between the i^{th} road segment and the (i+1)^{th} road segment.

In some aspects, the reachability condition includes a third reachability condition, the i^{th} road segment is located on a first plane, the (i+1)^{th} road segment is located on a second plane, and the first plane is higher than the second plane.

In some aspects, the processing module is configured to:

determine a falling point of the virtual object corresponding to the AI model, the falling point being a starting location point of a free fall motion of the virtual object;

determine a preset side of the (i+1)^{th} road segment that is closest to the i^{th} road segment; and

determine, when a distance between the preset side and a free fall route of the virtual object is less than or equal to a second set distance, that the third reachability condition is satisfied between the i^{th} road segment and the (i+1)^{th} road segment,

the second set distance being determined based on a model width of the virtual object.

In some aspects, the processing module is configured to:

determine a movement speed of the virtual object corresponding to the AI model on the i^{th} road segment;

determine a location point corresponding to reduction of the movement speed to 0 as the falling point, or

determine a jump starting point of the virtual object on the i^{th} road segment;

determine a plurality of jump curves based on the jump starting point and a jump height of the virtual object;

determine a jump curved surface based on the plurality of jump curves; and

determine an intersection point between the jump curved surface and the first plane as the falling point.

In some aspects, the verification stop condition includes at least one of the following: The N road segments of the at least one route are all traversed, the i^{th} road segment currently verified is a road segment on which an end point of the at least one route is located, there is no (i+1)^{th} road segment corresponding to the i^{th} road segment currently verified, and there is no error location point in the game level. The end point is set when the game level is pre-created.

In some aspects, the processing module is configured to:

trigger, based on the type of the error location point, optimization on the game content corresponding to the error location point.

In some aspects, the error location point is a location point between the i^{th} road segment and the (i+1)^{th} road segment on the at least one route of the game level.

In some aspects, the processing module is configured to:

determine the preset side of the (i+1)^{th} road segment that is closest to the i^{th} road segment; and

pull the preset side based on a direction of the i^{th} road segment, to stretch the (i+1)^{th} road segment by a first length, so that the first reachability condition is satisfied between the i^{th} road segment and the (i+1)^{th} road segment; or

pull the preset side based on a direction of the i^{th} road segment, to stretch the (i+1)^{th} road segment by a second length, and translate the (i+1)^{th} road segment by a third length based on a vertical axis, so that the second reachability condition is satisfied between the i^{th} road segment and the (i+1)^{th} road segment; or

pull the preset side based on a direction of the i^{th} road segment, to stretch the (i+1)^{th} road segment by a fourth length, so that the third reachability condition is satisfied between the i^{th} road segment and the (i+1)^{th} road segment.

For specific limitations in one or more aspects of the game level verification information apparatus 800 provided above, refer to the foregoing limitations on the game level verification method. Details are not described herein again. The modules of the foregoing apparatus may be all or partially implemented by software, hardware, and a combination thereof. Each module may be embedded in or independent of a processor of a computer device in a form of hardware, or may be stored in a memory of a computer device in a form of software, for a processor to invoke to perform an operation corresponding to the module.

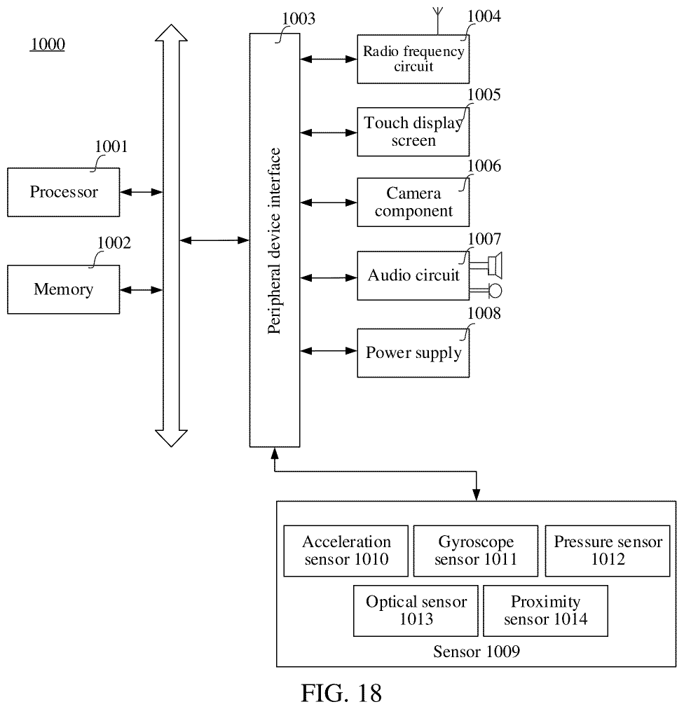

FIG. 18 is a block diagram of a structure of a computer device according to an illustrative aspect as described herein.

The computer device 1000 may be a portable mobile terminal, for example, a smartphone, a tablet computer, a moving picture experts group audio layer III (MP3) player, or a moving picture experts group audio layer IV (MP4) player. The computer device 1000 may also be referred to as user equipment, a portable terminal, or another name.

Generally, the computer device 1000 includes a processor 1001 and a memory 1002.

The processor 1001 may include one or more processing cores, for example, a four-core processor or an eight-core processor. The processor 1001 may be implemented in at least one hardware form of a digital signal processor (DSP), a field programmable gate array (FPGA), and a programmable logic array (PLA). The processor 1001 may alternatively include a main processor and a coprocessor. The main processor is a processor configured to process data in an awake state, and is also referred to as a central processing unit (CPU). The coprocessor is a low power consumption processor configured to process the data in a standby state. In some aspects, the processor 1001 may be integrated with a graphics processing unit (GPU), and the GPU is configured to render and draw content that needs to be displayed on a display screen. In some aspects, the processor 1001 may alternatively include an artificial intelligence (AI) processor. The AI processor is configured to process computing operations related to machine learning.

The memory 1002 may include one or more computer-readable storage media. The computer-readable storage medium may be tangible and non-transitory. The memory 1002 may further include a high-speed random access memory and a non-volatile memory, for example, one or more disk storage devices and flash storage devices. In some aspects, the non-transitory computer-readable storage medium in the memory 1002 is configured to store at least one instruction, and the at least one instruction is configured for being executed by the processor 1001 to implement the game level verification method provided in the aspects as described herein.

In some aspects, the computer device 1000 may include a peripheral device interface 1003 and at least one peripheral device. Specifically, the peripheral device includes at least one of a radio frequency circuit 1004, a touch display screen 1005, a camera component 1006, an audio circuit 1007, and a power supply 1008.

The peripheral device interface 1003 may be configured to connect at least one peripheral device related to input/output (I/O) to the processor 1001 and the memory 1002. In some aspects, the processor 1001, the memory 1002, and the peripheral device interface 1003 are integrated on a same chip or circuit board. In some other aspects, any one or two of the processor 1001, the memory 1002, and the peripheral device interface 1003 may be implemented on a single chip or circuit board. This is not limited in this aspect.

The radio frequency circuit 1004 is configured to receive and transmit a radio frequency (RF) signal, which is also referred to as an electromagnetic signal. The radio frequency circuit 1004 communicates with a communication network and another communication device by using the electromagnetic signal. The radio frequency circuit 1004 converts an electric signal into an electromagnetic signal for transmission, or converts a received electromagnetic signal into an electric signal. In some aspects, the radio frequency circuit 1004 includes an antenna system, an RF transceiver, one or more amplifiers, a tuner, an oscillator, a digital signal processor, a codec chipset, a subscriber identity module card, and the like. The RF circuit 1004 may communicate with another terminal by using at least one wireless communication protocol. The wireless communication protocol includes but is not limited to a world wide web, a metropolitan area network, an intranet, generations of mobile communication networks (2^{nd} generation (2G), 3^{rd} generation (3G), 4^{th} generation (4G), and 5^{th} generation (5G)), a wireless local area network, and/or a wireless fidelity (Wi-Fi) network. In some aspects, the radio frequency circuit 1004 may further include a circuit related to near field communication (NFC). This is not limited as described herein.

The touch display screen 1005 is configured to display a user interface (UI). The UI may include a graph, a text, an icon, a video, and any combination thereof. The touch display screen 1005 further has a capability of acquiring a touch signal on or above a surface of the touch display screen 1005. The touch signal may be inputted to the processor 1001 as a control signal for processing. The touch display screen 1005 is configured to provide a virtual button and/or a virtual keyboard that are/is also referred to as a soft button and/or a soft keyboard. In some aspects, there may be one touchscreen 1005 disposed on a front panel of the computer device 1000. In some other aspects, there may be at least two touchscreens 1005 disposed on different surfaces of the computer device 1000 or in a folded design. In some aspects, the touch display screen 1005 may be a flexible display screen, and is disposed on a curved surface or a folded surface of the computer device 1000. Even, the touch display screen 1005 may alternatively be further configured in a non-rectangular irregular pattern, that is, is a special-shaped screen. The touch display screen 1005 may be prepared using materials such as a liquid crystal display (LCD) and an organic light-emitting diode (OLED).

The camera component 1006 is configured to acquire images or videos. In some aspects, the camera component 1006 includes a front camera and a rear camera. Generally, the front camera is configured to implement a video call or self-portrait, and the rear camera is configured to shoot a picture or a video. In some aspects, there are at least two rear cameras, each of which is any one of a main camera, a depth of field camera, and a wide-angle camera, to implement a background blurring function by fusing the main camera and the depth of field camera, and panoramic shooting and virtual reality (VR) shooting functions by fusing the main camera and the wide-angle camera. In some aspects, the camera component 1006 may further include a flash. The flash may be a mono color temperature flash or a double color temperature flash. The double color temperature flash is a combination of a warm light flash and a cold light flash, and may be configured for light compensation under different color temperatures.

The audio circuit 1007 is configured to provide an audio interface between a user and the computer device 1000. The audio circuit 1007 may include a microphone and a speaker. The microphone is configured to acquire sound waves of the user and an environment, convert the sound waves into an electric signal, and input the electric signal to the processor 1001 for processing, or input the electric signal to the radio frequency circuit 1004 for implementing voice communication. For the purpose of stereo acquisition or noise reduction, there may be a plurality of microphones disposed at different parts of the computer device 1000. The microphone may alternatively be an array microphone or an omni-directional capture microphone. The speaker is configured to convert electric signals from the processor 1001 or the radio frequency circuit 1004 into sound waves. The speaker may be a conventional film speaker or a piezoelectric ceramic speaker. When the speaker is the piezoelectric ceramic speaker, the speaker can not only convert an electric signal into acoustic waves audible to a human being, but also can convert an electric signal into acoustic waves inaudible to a human being, for ranging and other purposes. In some aspects, the audio circuit 1007 may further include a headset jack.

The power supply 1008 is configured to supply power to each component of the computer device 1000. The power supply 1008 may be alternating current, direct current, a primary battery, or a rechargeable battery. When the power supply 1008 includes a rechargeable battery, the rechargeable battery may be a wired rechargeable battery or a wireless rechargeable battery. The wired rechargeable battery is a battery charged through a wired cable. The wireless rechargeable battery is a battery charged through a wireless coil. The rechargeable battery may alternatively be configured to support a fast charge technology.

In some aspects, the computer device 1000 further includes one or more sensors 1009. The one or more sensors 1009 include but are not limited to an acceleration sensor 1010, a gyroscope sensor 1011, a pressure sensor 1012, an optical sensor 1013, and a proximity sensor 1014.

The acceleration sensor 1010 may detect a magnitude of acceleration on three coordinate axes of a coordinate system established by the computer device 1000. For example, the acceleration sensor 1010 may be configured to detect components of gravity acceleration on the three coordinate axes. The processor 1001 may control, based on a gravity acceleration signal acquired by the acceleration sensor 1010, the touch display screen 1005 to display the user interface in a landscape view or a portrait view. The acceleration sensor 1010 may alternatively be configured to collect motion data of a game or the user.

The gyroscope sensor 1011 may detect a body direction and a rotation angle of the computer device 1000. The gyroscope sensor 1011 may cooperate with the acceleration sensor 1010 to acquire a three-dimensional (3D) action performed by the user on the computer device 1000. The processor 1001 may implement the following functions based on the data acquired by the gyroscope sensor 1011: motion sensing (such as changing the UI based on a tilt operation of the user), image stabilization at shooting, game control, and inertial navigation.

The pressure sensor 1012 may be disposed at a side frame of the computer device 1000 and/or a lower layer of the touch display screen 1005, When the pressure sensor 1012 is disposed at the side frame of the computer device 1000, a holding signal of the user on the computer device 1000 may be detected, and left and right hand recognition or a quick operation may be performed based on the holding signal. When the pressure sensor 1012 is disposed at the low layer of the touch display screen 1005, an operable control on the UI may be controlled based on a pressure operation of the user on the touch display screen 1005. The operable control includes at least one of a button control, a scroll bar control, an icon control, and a menu control.

The optical sensor 1013 is configured to acquire an ambient light intensity. In an aspect, the processor 1001 may control display brightness of the touch display screen 1005 based on the ambient light intensity acquired by the optical sensor 1013. Specifically, when the ambient light intensity is high, the display brightness of the touch display screen 1005 is increased; or when the ambient light intensity is low, the display brightness of the display screen 1005 is decreased. In another aspect, the processor 1001 may further dynamically adjust a camera parameter of the camera component 1006 based on the ambient light intensity acquired by the optical sensor 1013.

The proximity sensor 1014, also referred to as a distance sensor, is generally disposed on a front surface of the computer device 1000. The proximity sensor 1014 is configured to acquire a distance between the user and the front surface of the computer device 1000. In an aspect, when the proximity sensor 1014 detects that the distance between the user and the front surface of the computer device 1000 gradually decreases, the processor 1001 controls the touch display screen 1005 to switch from a screen-on state to a screen-off state; or when the proximity sensor 1014 detects that the distance between the user and the front surface of the computer device 1000 gradually increases, the processor 1001 controls the touch display screen 1005 to switch from a screen-off state to a screen-on state.

It may be understood by a person skilled in the art that the structure shown in FIG. 18 does not form a limitation on the computer device 1000, and more or fewer components than those shown in the figure may be included, or some components are combined, or different component arrangements are used.

In an illustrative aspect, this application provides a chip. The chip includes a programmable logic circuit and/or program instructions. When the chip is run on a computer device, the chip is configured to implement the game level verification method according to the foregoing method aspects.

This application provides a computer-readable storage medium. The computer-readable storage medium has a computer program stored therein. The computer program is loaded and executed by a processor to implement the game level verification method according to the foregoing method aspects.

This application provides a computer program product or a computer program. The computer program product or the computer program includes computer instructions, and the computer instructions are stored in a computer-readable storage medium. A processor of a computer device reads the computer instructions from the computer-readable storage medium. The processor executes the computer instructions, so that the processor of the computer device loads and executes the computer instructions to implement the game level verification method according to the foregoing method aspects.

The sequence numbers of the aspects as described herein are merely for description and do not represent superiority-inferiority of the aspects.

A person of ordinary skill in the art may understand that all or a part of the operations in the foregoing aspects may be implemented by hardware, or may be implemented by a program instructing related hardware. The program may be stored in a computer-readable storage medium. The computer-readable storage medium may be a read-only memory, a magnetic disk, an optical disc, or the like.

A person skilled in the art may be aware that in the foregoing one or more examples, the functions described in the aspects as described herein may be implemented by hardware, software, firmware, or any combination thereof. When implemented by software, the functions may be stored in a computer-readable medium or transmitted as one or more instructions or code in a computer-readable medium. The computer-readable medium includes a computer storage medium and a communication medium. The communication medium includes any medium that enables a computer program to be transmitted from one place to another. The storage medium may be any available medium accessible to a general-purpose or special-purpose computer.

The foregoing descriptions are merely illustrative aspects as described herein, but are not intended to limit this application. Any modification, equivalent replacement, or improvement made within the spirit and principle as described herein shall fall within the protection scope as described herein.

What is claimed is:

1. A computer implemented method comprising:
loading a pre-created game level for a virtual environment;
initiating a verification operation using an artificial intelligence (AI) model to verify game content of the pre-created game level; and
generating error reporting information for the pre-created game level in response to the verification operation, wherein the error reporting information comprising one or more error location points in the game level, wherein each location point is a location point corresponding to game content that the AI model fails to pass in the virtual environment.

2. The method of claim 1, further comprising:
displaying a demo screen in response to the verification operation, the demo screen being a screen for watching a demo of the game content of the game level by a virtual object, and the virtual object being a visual model corresponding to the AI model in the game level; and
displaying the error reporting information on the demo screen.

3. The method of claim 2, wherein the displaying the error reporting information on the demo screen comprises:
displaying an error reporting element corresponding to one of the error location points at the corresponding error location point in the demo screen, indicating the error location point in the pre-created game level.

4. The method of claim 2, further comprising:
for each error location point, displaying corresponding error reporting prompt text in a text display region in the demo screen, wherein each error reporting prompt text being indicates a type of the error location point, wherein the type comprising failing to pass the error location point in at least one of a walking manner, a jumping manner, a climbing manner, and/or a falling manner.

5. The method of claim 2, wherein the game level comprises at least one route; and
the displaying the demo screen comprises:
displaying the virtual object attempting to complete the pre-created game level along the at least one route.

6. The method of claim 5, wherein the at least one virtual object comprises a first virtual object and a second virtual object, and the second virtual object is obtained by duplicating the first virtual object; and
wherein the at least one route comprises at least one common road segment and at least two forked road segments,
wherein there is at least one first virtual object on the at least one common road segment and there is at least one second virtual object on each of the at least two forked road segments, and a quantity of the second virtual objects corresponds to a quantity of the at least two forked road segments.

7. The method of claim 1, wherein the method further comprises:
displaying an optimization button based on a location of each error location point, wherein each optimization button is configured for triggering optimization on the game content corresponding to that error location point.

8. The method of claim 7, further comprising:
responsive to receiving a trigger operation on an optimization button corresponding to one of the error location points, optimizing game content corresponding to the one error location point based on a type of the one error location point, wherein optimization for a first type of error location point is different from optimization for a second type of error location point.

9. The method of claim 7, wherein the method further comprises:
triggering, in response to a trigger operation for the optimization button, optimization on the game content corresponding to the error location point;
ceasing display of the error reporting information in response to completion of optimization on the game content; and
ceasing display of the corresponding optimization button.

10. The method of claim 5, wherein the method further comprises:
determining a starting point of the at least one route in the game level, the starting point being set when the game level is pre-created, the at least one route comprising N road segments, and N being an integer greater than or equal to 1;
determining, based on the starting point, an i^{th} road segment currently verified, i being an integer greater than or equal to 1 and less than or equal to N;
determining an (i+1)^{th} road segment corresponding to the i^{th} road segment;
determining, when a reachability condition is satisfied between the i^{th} road segment and the (i+1)^{th} road segment, that there is no game content that the AI model fails to pass between the i^{th} road segment and the (i+1)^{th} road segment, or determining, when a reachability condition is not satisfied between the i^{th} road segment and the (i+1)^{th} road segment, a location point between the i^{th} road segment and the (i+1)^{th} road segment as an error location point; and
updating i to i+1, and performing again the operation of determining an (i+1)^{th} road segment corresponding to the i^{th} road segment, until a verification stop condition is satisfied, to determine the error location point in the game level.

11. The method of claim 10, wherein the determining the (i+1)^{th} road segment comprises:
emitting a ray in a preset direction using a road segment model of the i^{th} road segment as an endpoint; and
determining, when the ray has an intersection with another road segment, the another road segment as the (i+1)^{th} road segment corresponding to the i^{th} road segment.

12. The method of claim 11, wherein the i^{th} road segment and the (i+1)^{th} road segment are located on a same plane, and the method further comprises:
determining a shortest distance between the i^{th} road segment and the (i+1)^{th} road segment; and
determining, when the shortest distance is less than or equal to a first set distance, that the reachability condition is satisfied between the i^{th} road segment and the (i+1)^{th} road segment,
wherein the first set distance comprises at least one of a maximum walking step length and a maximum jump step length of the virtual object corresponding to the AI model, the maximum walking step length being a maximum distance between a walking starting point and a walking landing point, and the maximum jump step length being a maximum distance between a jump starting point and a jump landing point.

13. The method of claim 11, wherein the i^{th} road segment is located on a first plane, the (i+1)^{th} road segment is located on a second plane, and the first plane is lower than the second plane, and the method further comprises:
determining a jump starting point of the virtual object corresponding to the AI model on the i^{th} road segment;
determining a plurality of jump curves based on the jump starting point and a jump height of the virtual object;
determining a jump curved surface based on the plurality of jump curves; and
determining, when the second plane corresponding to the (i+1)^{th} road segment has an intersection with the jump curved surface, that the reachability condition is satisfied between the i^{th} road segment and the (i+1)^{th} road segment.

14. The method of claim 11, wherein the i^{th} road segment is located on a first plane, the (i+1)^{th} road segment is located on a second plane, and the first plane is higher than the second plane, and the method further comprises:
determining a falling point of the virtual object corresponding to the AI model, the falling point being a starting location point of a free fall motion of the virtual object;
determining a preset side of the (i+1)^{th} road segment that is closest to the i^{th} road segment; and
determining, when a distance between the preset side and a free fall route of the virtual object is less than or equal to a second set distance, that the reachability condition is satisfied between the i^{th} road segment and the (i+1)^{th} road segment,
the second set distance being determined based on a model width of the virtual object.

15. One or more non-transitory computer readable media comprising computer readable instructions that, when executed by a processor, configure a data processing system to perform:
loading a pre-created game level for a virtual environment;
initiating a verification operation using an artificial intelligence (AI) model to verify game content of the pre-created game level;
generating error reporting information for the pre-created game level in response to the verification operation, wherein the error reporting information comprising one or more error location points in the game level, wherein each location point is a location point corresponding to game content that the AI model fails to pass in the virtual environment,
displaying a demo screen in response to the verification operation, the demo screen being a screen for watching a demo of the game content of the game level by a virtual object, and the virtual object being a visual model corresponding to the AI model in the game level; and
displaying the error reporting information on the demo screen.

16. The computer readable media of claim 15, wherein the displaying the error reporting information on the demo screen comprises:
displaying an error reporting element corresponding to one of the error location points at the corresponding error location point in the demo screen, indicating the error location point in the pre-created game level; and
for each error location point, displaying corresponding error reporting prompt text in a text display region in the demo screen, wherein each error reporting prompt text being indicates a type of the error location point, wherein the type comprising failing to pass the error location point in at least one of a walking manner, a jumping manner, a climbing manner, and/or a falling manner.

17. The computer readable media of claim 15, wherein the instruction, when executed, further configure the data processing system to perform:
displaying an optimization button based on a location of each error location point, wherein each optimization button is configured for triggering optimization on the game content corresponding to that error location point, and wherein optimization for a first type of error location point is different from optimization for a second type of error location point.

18. A system comprising: a processor, and memory storing computer readable instructions that, when executed by the processor, configure the system to perform:
loading a pre-created game level for a virtual environment;
initiating a verification operation using an artificial intelligence (AI) model to verify game content of the pre-created game level;
generating error reporting information for the pre-created game level in response to the verification operation, wherein the error reporting information comprising one or more error location points in the game level, wherein each location point is a location point corresponding to game content that the AI model fails to pass in the virtual environment,
displaying a demo screen in response to the verification operation, the demo screen being a screen for watching a demo of the game content of the game level by a virtual object, and the virtual object being a visual model corresponding to the AI model in the game level; and
displaying the error reporting information on the demo screen.

19. The system of claim 18, wherein the displaying the error reporting information on the demo screen comprises:
displaying an error reporting element corresponding to one of the error location points at the corresponding error location point in the demo screen, indicating the error location point in the pre-created game level; and
for each error location point, displaying corresponding error reporting prompt text in a text display region in the demo screen, wherein each error reporting prompt text being indicates a type of the error location point, wherein the type comprising failing to pass the error location point in at least one of a walking manner, a jumping manner, a climbing manner, and/or a falling manner.

20. The system of claim 18, wherein the instruction, when executed, further configure the system to perform:
displaying an optimization button based on a location of each error location point, wherein each optimization button is configured for triggering optimization on the game content corresponding to that error location point, and wherein optimization for a first type of error location point is different from optimization for a second type of error location point.
